(19) United States
(12) Patent Application Publication
(10) Pub. No.: US 2022/0317269 A1
(43) Pub. Date: Oct. 6, 2022

(54) SIGNAL PROCESSING DEVICE, SIGNAL PROCESSING METHOD, AND RANGING MODULE

(71) Applicant: SONY GROUP CORPORATION, Tokyo (JP)

(72) Inventors: Hajime MIHARA, Tokyo (JP); Shun KAIZU, Kanagawa (JP)

(73) Assignee: SONY GROUP CORPORATION, Tokyo (JP)

(21) Appl. No.: 17/608,059

(22) PCT Filed: May 15, 2020
(86) PCT No.: PCT/JP2020/019375

§ 371 Date: Nov. 1, 2021

(30) Foreign Application Priority Data
May 31, 2019 (JP) 2019-102151

(51) Int. Cl. G01S 7/486; G01S 17/894

(52) U.S. Cl. CPC G01S 7/4868; G01S 17/894

(57) ABSTRACT

There is provided a signal processing device, a signal processing method, and a ranging module that enable appropriate exposure control. A parameter determination unit of the ranging module determines an exposure control parameter on the basis of an evaluation index using distance information and luminance information calculated from a detection signal of a light reception unit. The present technology may be applied to, for example, a ranging module that performs ranging by an indirect ToF method and the like.

### TECHNICAL FIELD

The present technology relates to a signal processing device, a signal processing method, and a ranging module, and especially relates to a signal processing device, a signal processing method, and a ranging module that enable appropriate exposure control.

### BACKGROUND ART

A ranging sensor using an indirect time of flight (ToF) method is known. In the ranging sensor of the indirect ToF method, signal electric charges obtained by receiving reflected light reflected by a measurement target are distributed to two electric charge accumulation regions, and a distance is calculated from a distribution ratio of the signal electric charges. As such ranging sensor, a ranging sensor of a backside illumination type with improved light receiving characteristic is proposed (refer to, for example, Patent Document 1).

### CITATION LIST

### Patent Document

Patent Document 1: International Publication No. 2018/135320

### SUMMARY OF THE INVENTION

### Problems to be Solved by the Invention

In a ranging sensor that receives reflected light, a light amount of ambient light such as sunlight and of a light emitting source affect a light reception amount, so that appropriate exposure control is required to accurately measure a distance.

The present technology is achieved in view of such a condition and an object thereof is to perform appropriate exposure control.

### Solutions to Problems

A signal processing device according to a first aspect of the present technology is provided with a parameter determination unit that determines an exposure control parameter on the basis of an evaluation index using distance information and luminance information calculated from a detection signal of a light receiving sensor.

In a signal processing method according to a second aspect of the present technology, a signal processing device determines an exposure control parameter on the basis of an evaluation index using distance information and luminance information calculated from a detection signal of a light receiving sensor.

A ranging module according to a third aspect of the present technology is provided with a light emission unit that emits light at a predetermined frequency, a light receiving sensor that receives reflected light that is light from the light emission unit reflected by an object, and a parameter determination unit that determines an exposure control parameter on the basis of an evaluation index using distance information and luminance information calculated from a detection signal of the light receiving sensor.

In the first to third aspects of the present technology, an exposure control parameter is determined on the basis of an evaluation index using distance information and luminance information calculated from a detection signal of a light receiving sensor.

The signal processing device and the ranging module may be independent devices or modules incorporated in other devices.

### BRIEF DESCRIPTION OF DRAWINGS

FIG. 1 is a block diagram illustrating a configuration example of one embodiment of a ranging module to which the present technology is applied.

FIG. 2 is a view for illustrating an operation of a pixel in an indirect ToF method.

FIG. 3 is a view for illustrating a detection method by four phases.

FIG. 4 is a view for illustrating a detection method by four phases.

FIG. 5 is a view for illustrating a method of calculating a depth value and reliability by a two-phase method and a four-phase method.

FIG. 6 is a view illustrating a relationship between a luminance value l and a variance σ²(l).

FIG. 7 is a view illustrating an SN ratio corresponding to a distance.

FIG. 8 is a view for illustrating an evaluation index when determining an exposure control parameter.

FIG. 9 is a view for illustrating a search for an evaluation value E.

FIG. 10 is a block diagram illustrating a first configuration example of a signal processing unit.

FIG. 11 is a flowchart for illustrating first depth map generation processing.

FIG. 12 is a block diagram illustrating a second configuration example of the signal processing unit.

FIG. 13 is a view for illustrating an SN ratio employed in the second configuration example.

FIG. 14 is a view for illustrating the evaluation index employed in the second configuration example.

FIG. 15 is a view illustrating an example of a plurality of SNRs.

FIG. 16 is a view illustrating contour lines of SNR.

FIG. 17 is a flowchart for illustrating second depth map generation processing.

FIG. 18 is a block diagram illustrating a third configuration example of the signal processing unit.

FIG. 19 is a view for illustrating a search for an exposure control parameter under a constraint condition.

FIG. 20 is a flowchart for illustrating third depth map generation processing.

FIG. 21 is a block diagram illustrating a fourth configuration example of the signal processing unit.

FIG. 22 is a view for illustrating setting of a region of interest.

FIG. 23 is a flowchart for illustrating fourth depth map generation processing.

FIG. 24 is a block diagram illustrating a configuration example of an electronic device to which the present technology is applied.

FIG. 25 is a block diagram illustrating a configuration example of one embodiment of a computer to which the present technology is applied.

FIG. 26 is a block diagram illustrating an example of a schematic configuration of a vehicle control system.

FIG. 27 is an illustrative view illustrating an example of installation positions of a vehicle exterior information detection unit and an imaging unit.

### MODE FOR CARRYING OUT THE INVENTION

A mode for carrying out the present technology (hereinafter, referred to as an embodiment) is hereinafter described. Note that, the description is given in the following order.

1. Configuration Example of Ranging Module

2. Pixel Operation in Indirect ToF Method

3. Method of Calculating Exposure Control Parameter of Signal Processing Unit

4. First Configuration Example of Signal Processing Unit

5. First Depth Map Generation Processing

6. Second Configuration Example of Signal Processing Unit

7. Second Depth Map Generation Processing

8. Third Configuration Example of Signal Processing Unit

9. Third Depth map Generation Processing

10. Fourth Configuration Example of Signal Processing Unit

11. Fourth Depth Map Generation Processing

12. First Variation

13. Second Variation

14. Third Variation

15. Summary

16. Configuration Example of Electronic Device

17. Configuration Example of Computer

18. Application Example to Mobile Body

### 1. Configuration Example of Ranging Module

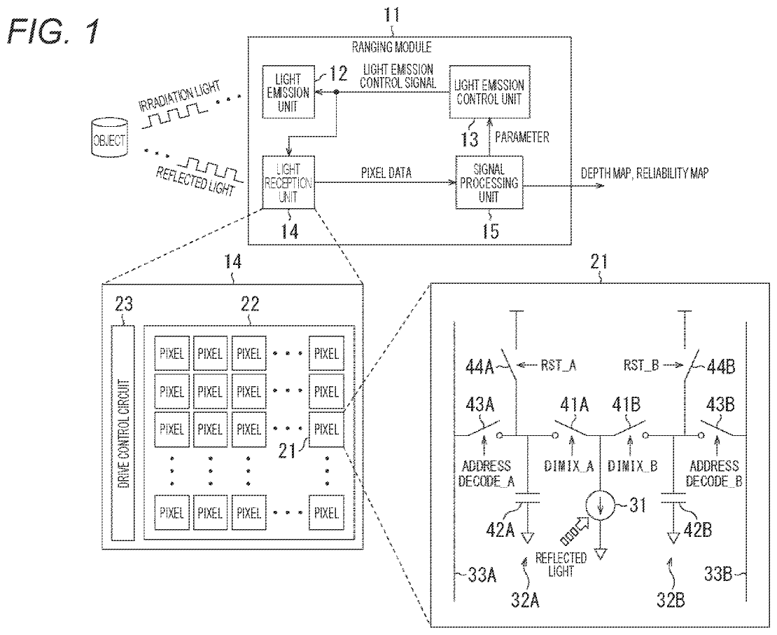

FIG. 1 is a block diagram illustrating a configuration example of one embodiment of a ranging module to which the present technology is applied.

A ranging module 11 illustrated in FIG. 1 is a ranging module (ToF module) that performs ranging by an indirect ToF method, and includes a light emission unit 12, a light emission control unit 13, a light reception unit 14, and a signal processing unit 15. The ranging module 11 irradiates an object with light and receives light (reflected light) that is the light (irradiation light) reflected by the object, thereby generating a depth map (distance image) as distance information to the object and a reliability map (reliability image) as luminance information to output.

The light emission unit 12 includes, for example, an infrared laser diode and the like as a light source, and emits light while modulating at a timing corresponding to a light emission control signal supplied from the light emission control unit 13 under control of the light emission control unit 13, and irradiates the object with the irradiation light.

The light emission control unit 13 controls light emission of the light emission unit 12 by supplying the light emission control signal that controls a frequency (for example, 20 MHz and the like) and a light emission amount when allowing the light source to emit light to the light emission unit 12. Furthermore, in order to drive the light reception unit 14 in accordance with a light emission timing of the light emission unit 12, the light emission control unit 13 supplies the light emission control signal also to the light reception unit 14.

The light reception unit 14 is provided with a pixel array unit 22 in which pixels 21 that generate electric charges corresponding to an amount of received light and output a signal corresponding to the electric charges are two-dimensionally arranged in a matrix in a row direction and a column direction, and a drive control circuit 23 is arranged in a peripheral region of the pixel array unit 22. The light reception unit 14 is a light receiving sensor that receives the reflected light, and is also referred to as a ToF sensor.

The light reception unit 14 receives the reflected light from the object by the pixel array unit 22 in which a plurality of pixels 21 is two-dimensionally arranged. Then, the light reception unit 14 supplies a detection signal corresponding to an amount of the reflected light received by each pixel 21 of the pixel array unit 22 to the signal processing unit 15 as pixel data.

The drive control circuit 23 outputs control signals (for example, a distribution signal DIMIX, a selection signal ADDRESS DECODE, a reset signal RST and the like to be described later) for controlling drive of the pixel 21 on the basis of, for example, the light emission control signal supplied from the light emission control unit 13 and the like.

The pixel 21 includes a photodiode 31, and a first tap 32 A and a second tap 32B that detect the electric charges photoelectrically converted by the photodiode 31. In the pixel 21, the electric charges generated in one photodiode 31 are distributed to the first tap 32A or the second tap 32B. Then, out of the electric charges generated in the photodiode 31, the electric charges distributed to the first tap 32A are output as a detection signal A from a signal line 33A, and the electric charges distributed to the second tap 32B are output as a detection signal B from a signal line 33B.

The first tap 32A includes a transfer transistor 41A, a floating diffusion (FD) unit 42A, a selection transistor 43A, and a reset transistor 44A. Similarly, the second tap 32B includes a transfer transistor 41B, a FD unit 42B, a selection transistor 43B, and a reset transistor 44B.

The signal processing unit 15 calculates a depth value that is a distance from the ranging module 11 to the object on the basis of the pixel data supplied from the light reception unit 14 for each pixel 21 of the pixel array unit 22. Moreover, the signal processing unit 15 generates the depth map in which the depth value (depth information) is stored as a pixel value of each pixel 21 of the pixel array unit 22 to output. Furthermore, the signal processing unit 15 also calculates reliability of the calculated depth value for each pixel 21 of the pixel array unit 22, and generates the reliability map in which the reliability (luminance information) is stored as the pixel value of each pixel 21 of the pixel array unit 22 to output.

Furthermore, the signal processing unit 15 calculates an optimal exposure control parameter when receiving the reflected light next time from the obtained depth map and reliability map, and supplies the same to the light emission control unit 13. The light emission control unit 13 generates the light emission control signal on the basis of the exposure control parameter from the signal processing unit 15.

### 2. Pixel Operation in Indirect ToF Method

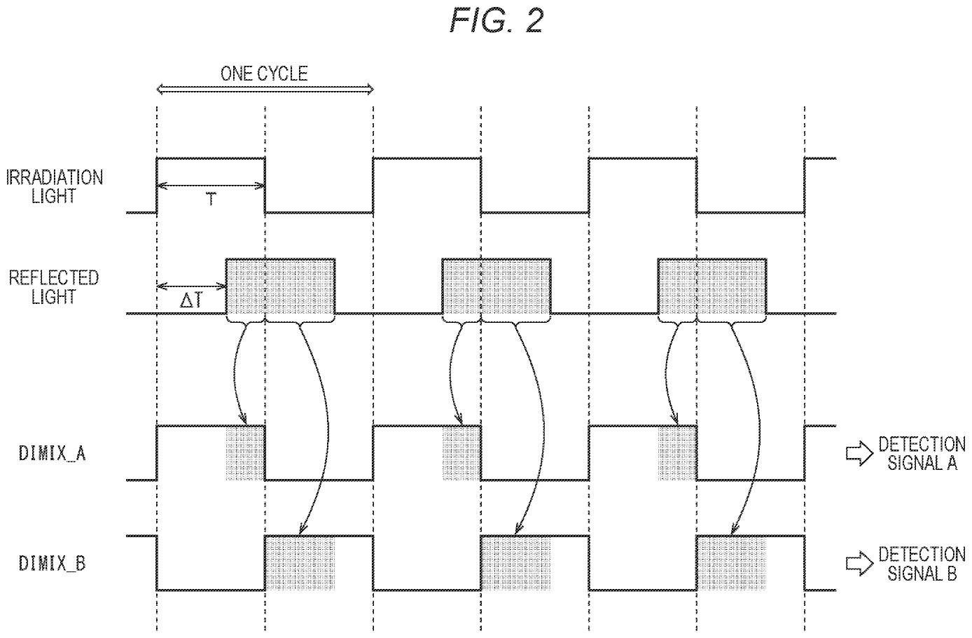

An operation of the pixel 21 in the indirect ToF method is described with reference to FIG. 2.

As illustrated in FIG. 2, the irradiation light modulated (one cycle=2T) so as to be repeatedly turned on/off at an irradiation time T is output from the light emission unit 12, and the reflected light is received by the photodiode 31 with a delay time ΔT corresponding to the distance to the object. Furthermore, a distribution signal DIMIX_A controls turning on/off of the transfer transistor 41A, and a distribution signal DIMIX_B controls turning on/off of the transfer transistor 41B. The distribution signal DIMIX_A is a signal in the same phase as the irradiation light, and the distribution signal DIMIX_B is in a phase obtained by inverting the distribution signal DIMIX_A.

Therefore, the electric charges generated when the photodiode 31 receives the reflected light are transferred to the FD unit 42A while the transfer transistor 41A is turned on according to the distribution signal DIMIX_A, and are transferred to the FD unit 42B while the transfer transistor 41B is turned on according to the distribution signal DIMIX_B. Therefore, in a predetermined period in which the irradiation with the irradiation light of the irradiation time T is periodically performed, the electric charges transferred via the transfer transistor 41A are sequentially accumulated in the FD unit 42A, and the electric charges transferred via the transfer transistor 41B are sequentially accumulated in the FD unit 42B.

Then, when the selection transistor 43A is turned on according to a selection signal ADDRESS DECODE_A after the period in which the electric charges are accumulated ends, the electric charges accumulated in the FD unit 42A are read out via the signal line 33A, and the detection signal A corresponding to the electric charge amount is output from the light reception unit 14. Similarly, when the selection transistor 43B is turned on according to a selection signal ADDRESS DECODE_B, the electric charges accumulated in the FD unit 42B are read out via the signal line 33B, and the detection signal B corresponding to the electric charge amount is output from the light reception unit 14. Furthermore, the electric charges accumulated in the FD unit 42A are discharged when the reset transistor 44A is turned on according to a reset signal RST_A, and the electric charges accumulated in the FD unit 42B are discharged when the reset transistor 44B is turned on according to a reset signal RST_B.

In this manner, the pixel 21 distributes the electric charges generated by the reflected light received by the photodiode 31 to the first tap 32A or the second tap 32B according to the delay time ΔT, and outputs the detection signal A and the detection signal B. Then, the delay time ΔT corresponds to a time in which the light emitted by the light emission unit 12 flies to the object, and flies to the light reception unit 14 after being reflected by the object, that is, corresponds to the distance to the object. Therefore, the ranging module 11 may obtain the distance to the object (depth value) according to the delay time ΔT on the basis of the detection signal A and the detection signal B.

Note that, in the pixel array unit 22, there is a case where the detection signals A and B are affected differently by the respective pixels 21 due to a deviation in characteristic (sensitivity difference) of elements such as the photodiode 31 and a pixel transistor such as the transfer transistor 41 and the like included in each pixel 21. Therefore, in the ranging module 11 of the indirect ToF method, a method of removing the sensitivity difference between the taps of the respective pixels by obtaining the detection signal A and the detection signal B by receiving the reflected light while changing the phase in the same pixel 21, thereby improving an SN ratio is employed.

As a method of receiving the reflected light while changing the phase and calculating the depth value, for example, a detection method by two phases (two-phase method) and a detection method by four phases (four-phase method) are described.

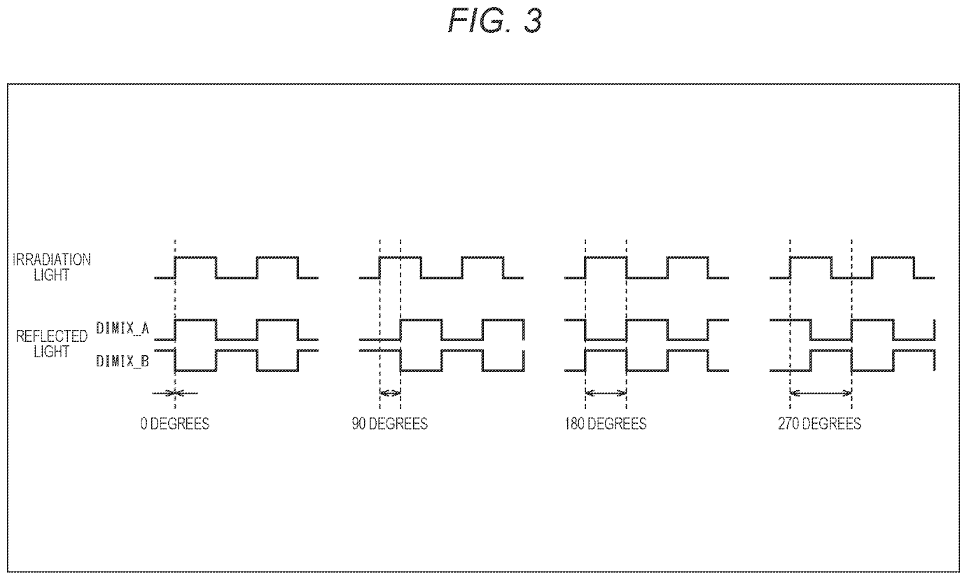

As illustrated in FIG. 3, the light reception unit 14 receives the reflected light at light reception timings with phases shifted by 0°, 90°, 180°, and 270° with respect to an irradiation timing of the irradiation light. More specifically, the light reception unit 14 receives the reflected light while changing the phase in a time division manner so as to receive the light with the phase set to 0° with respect to the irradiation timing of the irradiation light in a certain frame period, receive the light with the phase set to 90° in a next frame period, receive the light with the phase set to 180° in a next frame period, and receive the light with the phase set to 270° in a next frame period.

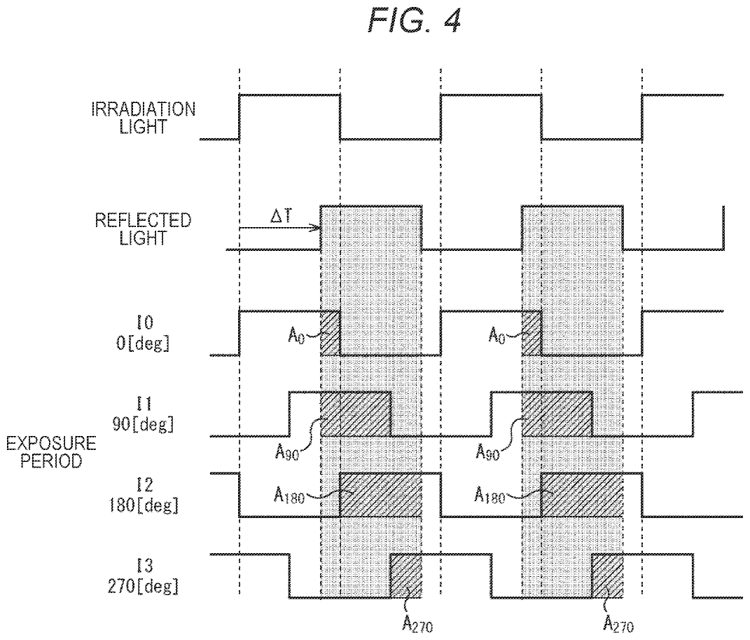

FIG. 4 is a view in which exposure periods of the first tap 32A of the pixel 21 in the respective phases of 0°, 90°, 180°, and 270° are arranged so that a phase difference is easily understood.

As illustrated in FIG. 4, in the first tap 32A, the detection signal A obtained by receiving the light in the same phase (phase 0°) as the irradiation light is referred to as a detection signal A₀, the detection signal A obtained by receiving the light in the phase (phase 90°) shifted by 90 degrees from the irradiation light is referred to as a detection signal A₉₀, the detection signal A obtained by receiving the light in the phase (phase 180°) shifted by 180 degrees from the irradiation light is referred to as a detection signal A₁₈₀, and the detection signal A obtained by receiving the light in the phase (phase 270°) shifted by 270 degrees from the irradiation light is referred to as a detection signal A₂₇₀.

Furthermore, although not illustrated, in the second tap 32B, the detection signal B obtained by receiving the light in the same phase (phase 0°) as the irradiation light is referred to as a detection signal B₀, the detection signal B obtained by receiving the light in the phase (phase 90°) shifted by 90 degrees from the irradiation light is referred to as a detection signal B₉₀, the detection signal B obtained by receiving the light in the phase (phase 180°) shifted by 180 degrees from the irradiation light is referred to as a detection signal B₁₈₀, and the detection signal B obtained by receiving the light in the phase (phase 270°) shifted by 270 degrees from the irradiation light is referred to as a detection signal B₂₇₀.

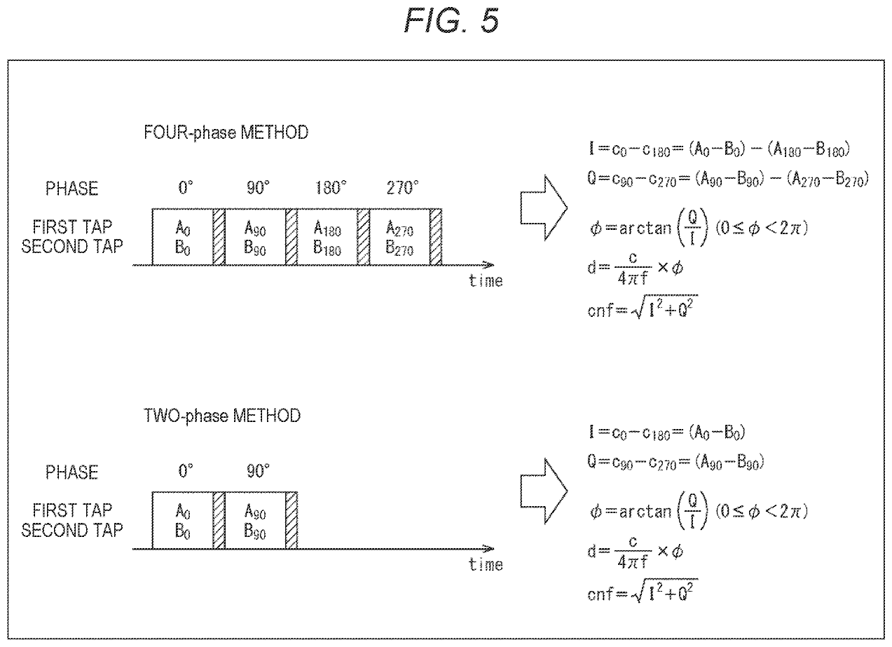

FIG. 5 is a view illustrating a method of calculating the depth value and the reliability by the two-phase method and the four-phase method.

In the indirect ToF method, a depth value d may be obtained by following expression (1).

$$\begin{matrix}[ Mathematical Expression 1 ] & \\ d = \frac{c \cdot Δ T}{2} = \frac{c \cdot ϕ}{4 π f} & ( 1 )\end{matrix}$$

In expression (1), c represents a speed of light, ΔT represents a delay time, and f represents a modulation frequency of light. Furthermore, φ, in expression (1) represents a phase shift amount [rad] of the reflected light and is expressed by following expression (2).

$$\begin{matrix}[ Mathematical Expression 2 ] & \\ ϕ = arctan ( \frac{Q}{I} ) ( 0 \leq ϕ < 2 π ) & ( 2 )\end{matrix}$$

In the four-phase method, I and Q in expression (2) are calculated by following expression (3) using the detection signals A₀ to A₂₇₀ and the detection signals B₀ to B₂₇₀ obtained by setting the phases to 0°, 90°, 180°, and 270°. I and Q represent signals obtained by converting, assuming that a change in luminance of the irradiation light is a cos wave, a phase of the cos wave from polar coordinates to orthogonal coordinate system (IQ plane).

I=c₀−c₁₈₀=(A₀−B₀)−(A₁₈₀−B₁₈₀)

Q=c₉₀−c₂₇₀=(A₉₀−B₉₀)−(A₂₇₀−B₂₇₀) (3)

In the four-phase method, for example, by taking a difference between the detection signals in the opposite phases of the same pixel as “A₀−A₁₈₀” or “A₉₀-A₂₇₀” in expression (3), it is possible to remove characteristic variation between the taps in the respective pixels, that is, the sensitivity difference between the taps.

In contrast, in the two-phase method, the depth value d to the object may be obtained using only two phases in an orthogonal relationship out of the detection signals A₀ to A₂₇₀ and the detection signals B₀ to B₂₇₀ obtained while setting the phases to 0°, 90°, 180°, and 270°. For example, in a case where the detection signals A₀ and B₀ in the phase 0° and the detection signals A₉₀ and B₉₀ in the phase 90° are used, I and Q in expression (2) are expressed by following expression (4).

I=c₀−c₁₈₀=(A₀−B₀)

Q=c₉₀−c₂₇₀=(A₉₀−B₉₀) (4)

For example, in a case where the detection signals A₁₈₀ and B₁₈₀ in the phase 180° and the detection signals A₂₇₀ and B₂₇₀ in the phase 270° are used, I and Q in expression (2) are expressed by following expression (5).

I=c₀−c₁₈₀=−(A₁₈₀−B₁₈₀)

Q=c₉₀−c₂₇₀=−(A₂₇₀−B₂₇₀) (₅)

In the two-phase method, the characteristic variation between the taps in each pixel cannot be removed, but the depth value d to the object may be obtained only by the detection signals in two phases, so that the ranging may be performed at a frame rate twice that of the four-phase method. The characteristic variation between the taps may be adjusted by a correction parameter if a gain, an offset and the like.

Reliability cnf is obtained by following expression (6) in both the two-phase method and the four-phase method.

### [Mathematical Expression 3]

cnf=\sqrt{I²+Q²} (6)

As is understood from expression (6), the reliability cnf corresponds to magnitude of the reflected light received by the pixel 21, that is, the luminance information (luminance value).

In this embodiment, the ranging module 11 may use either the I and Q signals corresponding to the delay time ΔT calculated by the four-phase method or the I and Q signals corresponding to the delay time ΔT calculated by the two-phase method to use the depth value d and the reliability cnf. Either the four-phase method or the two-phase method may be fixedly used, or for example, a method of appropriately selecting or blending them according to motion of the object and the like may be used. Hereinafter, for the sake of simplicity, it is assumed that the four-phase method is employed.

Note that, hereinafter, a unit for outputting one depth map is referred to as one frame (period), and a unit for generating pixel data (detection signal) in each phase of 0°, 90°, 180°, or 270° is referred to as a microframe (period). In the four-phase method, one frame includes four microframes, and in the two-phase method, one frame includes two microframes. Furthermore, in the following description, the depth value d is sometimes referred to as a distance d in order to facilitate understanding.

### 3. Method of Calculating Exposure Control Parameter of Signal Processing Unit

As described above, the signal processing unit 15 of the ranging module 11 generates the depth map and the reliability map on the basis of a light reception result of the reflected light by the four-phase method to output, and calculates the optimal exposure control parameter when receiving the reflected light next time from the obtained depth map and reliability map and supplies the same to the light emission control unit 13.

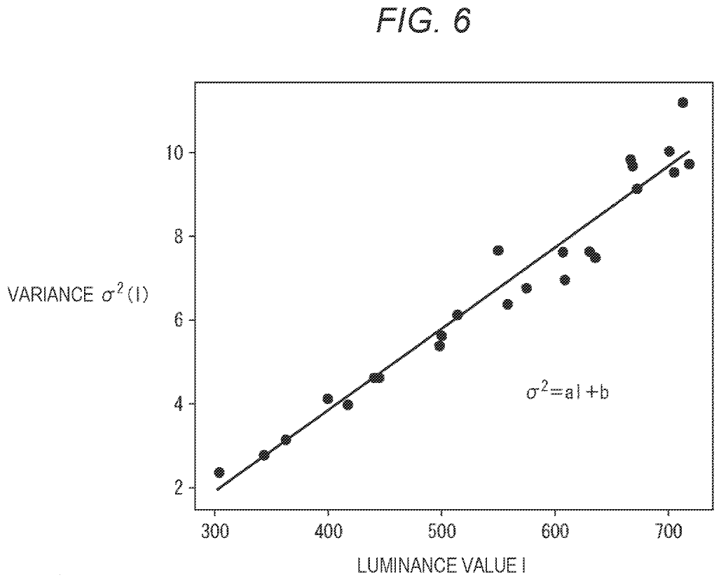

Therefore, next, a method of calculating the exposure control parameter by the signal processing unit 15 is described with reference to FIGS. 6 to 9.

First, it is assumed that additive noise (light shot noise) expressed by normal distribution with a mean of 0 and a variance of σ²(l) occurs in a luminance value 1 observed in each pixel 21 of the light reception unit 14 as the light receiving sensor. The variance σ²(1) is expressed by following expression (7).

σ²(l)=a·l+b (7)

Here, a and b represent values determined by a drive parameter such as a gain and the like of the light reception unit 14, and may be obtained by, for example, calibration in advance.

FIG. 6 illustrates a relationship between the luminance value l and the variance σ²(l) expressed by following expression (7). As illustrated in FIG. 6, the larger the luminance value l, the larger the variance σ²(l).

Furthermore, the indirect ToF method is a method of receiving light of a self-luminous light source as the reflected light, and from a property that intensity of light is inversely proportional to the square of a distance, it is possible to estimate in advance a luminance value of an object present at a predetermined distance.

For example, a luminance value l (r,p,t,d) at the distance d may be expressed by a model of following expression (8).

$$\begin{matrix}[ Mathematical Expression 4 ] & \\ l ( r , p , t , d ) = \frac{A ( r , p , t )}{{d}^{2}} + offset & ( 8 )\end{matrix}$$

In expression (8), d represents a distance, r represents a reflectance of an object, p represents a light emission amount of the light source of the light emission unit 12, and t represents an exposure time (accumulation time) of the pixel 21 of the light reception unit 14. A coefficient A (r,p,t) is a coefficient that is linear with respect to the reflectance r, the light emission amount p, and the exposure time t, and offset represents an offset constant.

Since the luminance information of the object present at the distance d may be estimated by the luminance value l (r,p,t,d) of expression (8) and variance corresponding to the luminance information may be expressed by σ²(l) of expression (7), so that SNR(d) that is an SN ratio corresponding to the distance d is expressed by following expression (9) using the luminance information.

$$\begin{matrix}[ Mathematical Expression 5 ] & \\ SNR ( d ) = \frac{l ( r , p , t , d )}{\sqrt{{σ}^{2} ( l ( r , p , t , d ) )}} & ( 9 )\end{matrix}$$

However, in a case where the distance to the object is short, the detection signal is saturated, and an accurate signal cannot be obtained. Therefore, considering the saturation, the SNR(d) may be expressed by expression (9)′.

$$\begin{matrix}[ Mathematical Expression 6 ] & \\ SNR ( d ) = \{ \begin{matrix}0 & if l ( r , p , t , d ) is Satulated \\ \frac{l ( r , p , t , d )}{\sqrt{{σ}^{2} ( l ( r , p , t , d ) )}} & otherwise\end{matrix} & {( 9 )}^{′}\end{matrix}$$

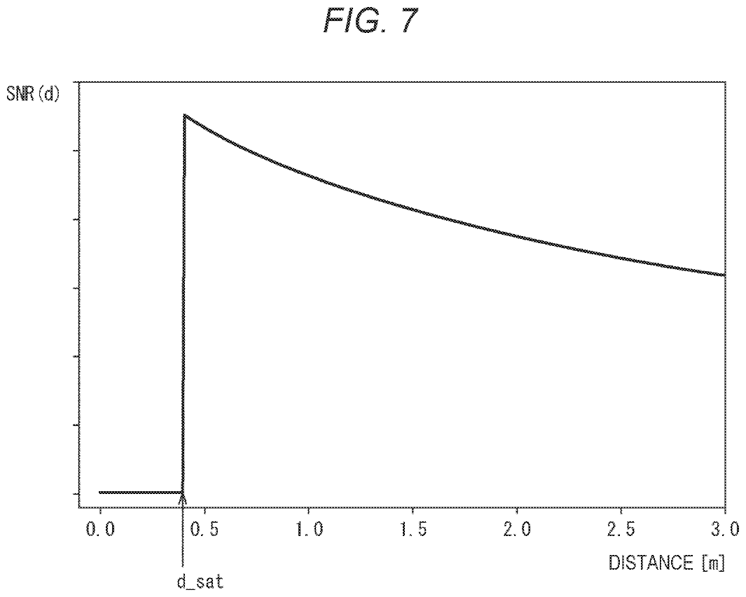

FIG. 7 illustrates an example of the SNR(d) of expression (9)′. A distance d_sat at which it is determined to be a saturated state in the SNR(d) in FIG. 7 may be determined according to sensor performance such as a saturated electric charge amount of the light reception unit 14 and the like, for example.

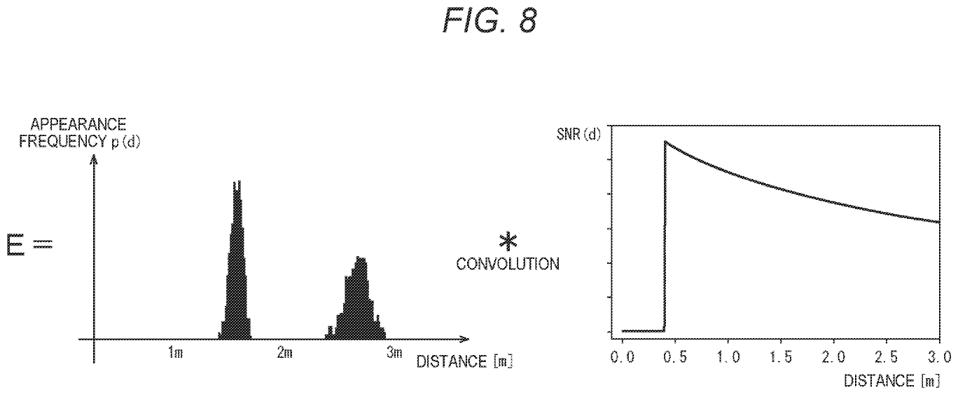

Here, assuming that the signal processing unit 15 employs a mean value of the SNRs(d) of all the pixels of the light reception unit 14 as an evaluation value E when determining the optimal exposure control parameter of the light reception unit 14, the evaluation value E may be expressed by an expression in which an appearance frequency p(d) of the distance d in the entire light reception unit 14 and the SNR(d) corresponding to the distance d are convoluted as illustrated in FIG. 8. In other words, the evaluation value E may be expressed by the sum of products of the appearance frequency p(d) and the SNR(d) for the distance d detected in one frame of following expression (10).

$$\begin{matrix}[ Mathematical Expression 7 ] & \\ E = {\sum }_{d} \{ SNR ( d ) \times p ( d ) \} & ( 10 )\end{matrix}$$

According to expression (10), the SN ratio expected when the reflected light is received with a current exposure control parameter may be found. Therefore, the signal processing unit 15 may search for the exposure control parameter with which the evaluation value E of expression (10) becomes maximum, thereby calculating the optimal exposure control parameter.

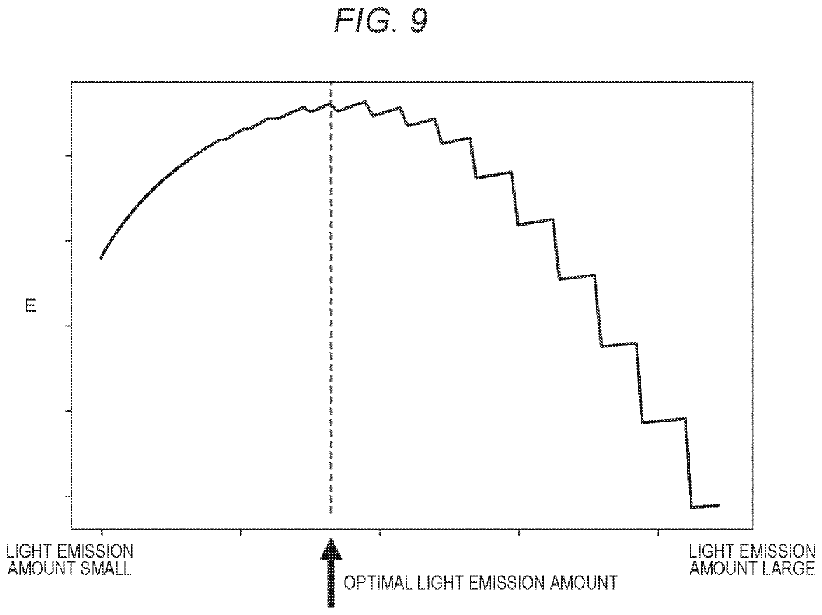

FIG. 9 illustrates a transition of the evaluation value E in a case where the exposure time t is fixed and the light emission amount p of the light source of the light emission unit 12 is sequentially changed as the exposure control parameters. The light emission amount p and the exposure time t with which the evaluation value E becomes maximum are the optimal exposure control parameters.

### 4. First Configuration Example of Signal Processing Unit

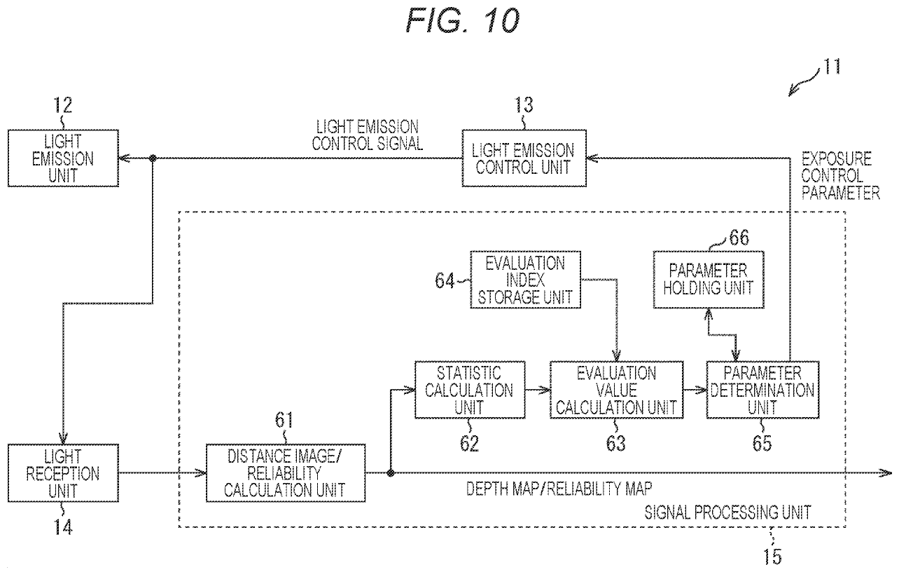

FIG. 10 is a block diagram illustrating a first configuration example of the signal processing unit 15 that executes processing of searching for an optimal value of the exposure control parameter described above. Note that FIG. 10 also illustrates the configuration other than this of the ranging module 11.

The signal processing unit 15 includes a distance image/reliability calculation unit 61, a statistic calculation unit 62, an evaluation value calculation unit 63, an evaluation index storage unit 64, a parameter determination unit 65, and a parameter holding unit 66. The signal processing unit 15 may be formed by using one signal processing chip or signal processing device. Furthermore, the light emission control unit 13 and the signal processing unit 15 may be formed by using one signal processing chip or signal processing device, or the light reception unit 14 and the signal processing unit 15 may be formed by using one signal processing chip or signal processing device.

The distance image/reliability calculation unit 61 calculates the distance d and the reliability cnf of each pixel 21 on the basis of the pixel data (detection signals A and B) of each pixel 21 supplied from the light reception unit 14. The method of calculating the distance d and the reliability cnf of each pixel is as described above.

The distance image/reliability calculation unit 61 generates the depth map (distance image) in which the distance d of each pixel 21 is stored as the pixel value of the pixel array unit 22 and the reliability map (reliability image) in which the reliability cnf of each pixel 21 is stored as the pixel value of the pixel array unit 22, and outputs the same to the outside.

Furthermore, the distance image/reliability calculation unit 61 supplies the depth map as the distance information and the reliability map as the luminance information also to the statistic calculation unit 62.

The statistic calculation unit 62 calculates a statistic of the depth map from one depth map supplied from the distance image/reliability calculation unit 61. Specifically, the statistic calculation unit 62 generates a histogram of the distance d obtained by counting the appearance frequency (frequency) of the distance d for all the pixels of the pixel array unit 22 illustrated in FIG. 8, and supplies the same to the evaluation value calculation unit 63.

The evaluation value calculation unit 63 calculates the evaluation value with the current exposure control parameter according to an evaluation index supplied by the evaluation index storage unit 64. Specifically, the evaluation value calculation unit 63 calculates the evaluation value E based on expression (10) supplied from the evaluation index storage unit 64 as the evaluation index, and supplies a result thereof to the parameter determination unit 65.

The evaluation index storage unit 64 stores an arithmetic expression of the evaluation value E of expression (10) as the evaluation index and expression (9)′ representing the SNR corresponding to the distance d and supplies the same to the evaluation value calculation unit 63. The evaluation value E of expression (10) is a value calculated using the statistic of the depth map and the reliability map, and is, more specifically, a value calculated by an expression in which the appearance frequency p(d) of the distance d and the SNR(d) corresponding to the distance d are convoluted.

The parameter determination unit 65 determines whether or not the current exposure control parameter is a value with which the evaluation value E becomes maximum. Then, in a case where it is determined that the current exposure control parameter is not the value with which the evaluation value E becomes maximum, for example, this determines a next exposure control parameter by using a gradient method and the like and supplies the same to the light emission control unit 13. Furthermore, the parameter determination unit 65 supplies the current exposure control parameter and the evaluation value E at that time to the parameter holding unit 66 and allows the same to hold them. In a case where it is determined that the exposure control parameter with which the evaluation value E becomes maximum is searched for, the parameter determination unit 65 finishes updating the exposure control parameter. In this embodiment, the parameter determination unit 65 updates the light emission amount p of the light source of the light emission unit 12 as the exposure control parameter to be updated, and supplies the same to the parameter holding unit 66 and the light emission control unit 13.

The parameter holding unit 66 holds the exposure control parameter supplied from the parameter determination unit 65 and the evaluation value E at that time. The exposure control parameter and the evaluation value E held in the parameter holding unit 66 are referred to by the parameter determination unit 65 as necessary.

The light emission control unit 13 generates the light emission control signal based on the light emission amount p supplied from the parameter determination unit 65 as the updated exposure control parameter, and supplies the same to the light emission unit 12 and the light reception unit 14.

### 5. First Depth Map Generation Processing

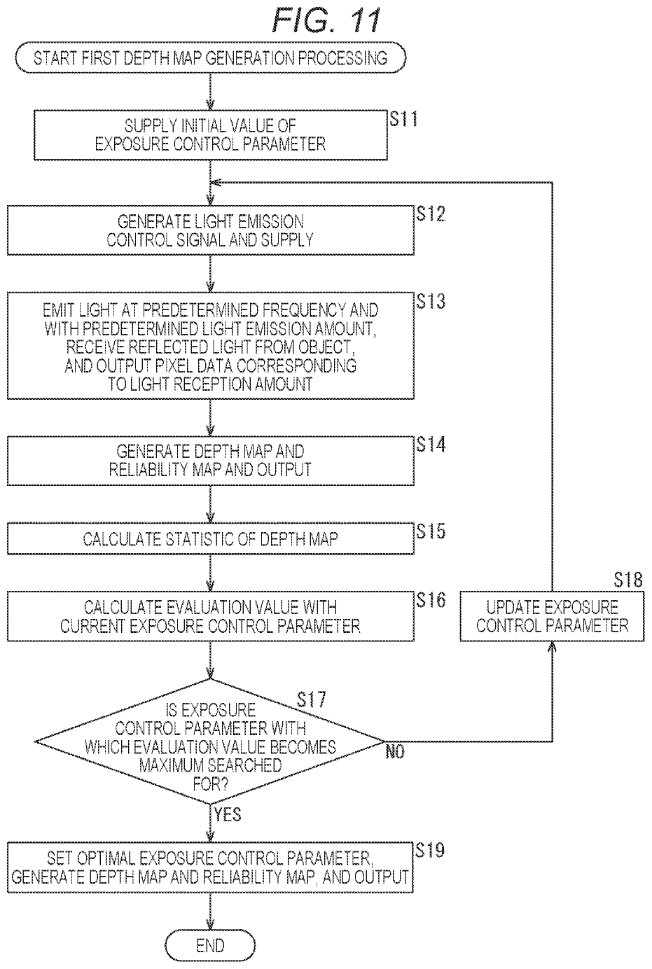

Next, depth map generation processing (first depth map generation processing) by the ranging module 11 having the first configuration example of the signal processing unit 15 is described with reference to a flowchart in FIG. 11. This processing is started, for example, when an instruction to start ranging is supplied to the ranging module 11.

First, at step S11, the parameter determination unit 65 supplies an initial value of the exposure control parameter determined in advance to the light emission control unit 13.

At step S12, the light emission control unit 13 generates the light emission control signal on the basis of the exposure control parameter supplied from the parameter determination unit 65, and supplies the same to the light emission unit 12 and the light reception unit 14. In the light emission control signal, the frequency and the light emission amount when the light emission unit 12 emits light from the light source are defined. In the light reception unit 14, an exposure period (light reception period) is determined according to a light emission timing of the light source defined by the light emission control signal, and each pixel 21 of the pixel array unit 22 is driven.

At step S13, the light emission unit 12 emits light at a predetermined frequency and with a predetermined light emission amount based on the light emission control signal, and the light reception unit 14 receives the reflected light from the object that is the irradiation light emitted from the light emission unit 12 and reflected by the object to return. Then, each pixel 21 of the light reception unit 14 outputs the pixel data generated according to the light reception amount to the distance image/reliability calculation unit 61 of the signal processing unit 15. The light reception unit 14 receives the reflected light capable of generating one depth map by the four-phase method. That is, the light reception unit 14 receives light in four phases shifted by 0°, 90°, 180°, and 270° with respect to the light emission timing of the irradiation light, and outputs the pixel data obtained as a result to the distance image/reliability calculation unit 61.

At step S14, the distance image/reliability calculation unit 61 calculates the distance d and the reliability cnf of each pixel 21 on the basis of the pixel data of each pixel 21 supplied from the light reception unit 14, generates the depth map and the reliability map, and outputs the same to the outside. Furthermore, the distance image/reliability calculation unit 61 supplies the generated depth map and reliability map also to the statistic calculation unit 62.

At step S15, the statistic calculation unit 62 calculates the statistic of the depth map from one depth map supplied from the distance image/reliability calculation unit 61. Specifically, the statistic calculation unit 62 generates the histogram of the distance d illustrated in FIG. 8 obtained by counting the appearance frequency of the distance d for all the pixels of the pixel array unit 22, and supplies the same to the evaluation value calculation unit 63.

At step S16, the evaluation value calculation unit 63 calculates the evaluation value E with the current exposure control parameter according to the evaluation index supplied by the evaluation index storage unit 64. Specifically, the evaluation value calculation unit 63 calculates the evaluation value E of expression (10) supplied from the evaluation index storage unit 64 as the evaluation index, and supplies a result thereof to the parameter determination unit 65.

At step S17, the parameter determination unit 65 determines whether or not the exposure control parameter with which the evaluation value E becomes maximum is searched for. For example, in a case of searching for the exposure control parameter using the gradient method, the parameter determination unit 65 determines whether or not the exposure control parameter with which the evaluation value E becomes maximum is searched for on the basis of whether or not a gradient falls within a predetermined range that may be regarded as 0. Alternatively, the parameter determination unit 65 may determine that the exposure control parameter with which the evaluation value E becomes maximum is searched for, in a case where the processing of searching for the exposure control parameter is repeated a predetermined number of times or a case where it is determined that there is no updating of the exposure control parameter with which the evaluation value E is improved.

In a case where it is determined at step S17 that the exposure control parameter with which the evaluation value E becomes maximum is not yet searched for, the procedure shifts to step S18, and the parameter determination unit 65 updates the exposure control parameter and supplies the same to the light emission control unit 13. Specifically, the parameter determination unit 65 supplies the exposure control parameter in which the light emission amount p of the light source is changed at a predetermined set width to the light emission control unit 13. Furthermore, at step S18 processing of allowing the parameter holding unit 66 to store the exposure control parameter before updating and the evaluation value E at that time is also performed. After step S18, the procedure returns to step S12, and the processes at steps S12 to S17 described above are repeated.

Then, in a case where it is determined at step S17 that the exposure control parameter with which the evaluation value E becomes maximum is searched for, the procedure shifts to step S19, and the ranging module 11 sets the exposure control parameter determined to be optimal, generates the depth map and the reliability map on the basis of the received reflected light, and outputs the same to the outside. That is, the parameter determination unit 65 supplies the optimal exposure control parameter the evaluation value E with which is determined to become maximum to the light emission control unit 13 again. The light emission control unit 13 generates the light emission control signal on the basis of the optimal exposure control parameter supplied from the parameter determination unit 65, and supplies the same to the light emission unit 12 and the light reception unit 14. The light reception unit 14 receives the reflected light from the object and outputs the pixel data. The distance image/reliability calculation unit 61 generates the depth map and the reliability map with the optimal exposure control parameter and outputs the same to the outside.

Then, the first depth map generation processing is finished.

According to the first depth map generation processing, it is possible to search for and determine the exposure control parameter that maximizes the evaluation index on the basis of the evaluation index using the luminance information assumed according to the distance and the distance information of the object (subject) obtained by actually receiving the reflected light. Therefore, appropriate exposure control may be performed.

Note that, in the first depth map generation processing described above, the exposure control parameter determined to be optimal is supplied to the light emission control unit 13 again, and the depth map and the reliability map with the optimal exposure control parameter are generated again and output; however, it is also possible to allow the parameter holding unit 66 to store the depth map and the reliability map generated with each exposure control parameter being searched for, and obtain, in a case where the optimal exposure control parameter is fixed, the depth map and the reliability map at that time from the parameter holding unit 66 to output to the outside. Furthermore, although the depth maps and the reliability maps with the sequentially set exposure control parameters are output to the outside, it is also possible to output only the depth map and the reliability map with the optimal exposure control parameter to the outside.

### 6. Second Configuration Example of Signal Processing Unit

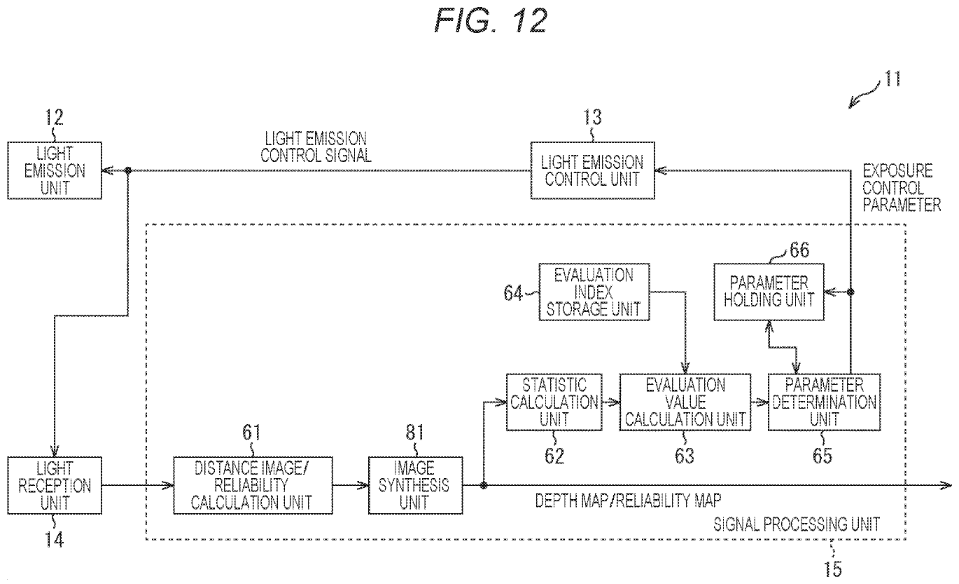

FIG. 12 is a block diagram illustrating a second configuration example of the signal processing unit 15. FIG. 12 also illustrates the configuration other than this of the ranging module 11.

In the second configuration example in FIG. 12, parts corresponding to those of the first configuration example illustrated in FIG. 10 are assigned with the same reference signs and description thereof is omitted as appropriate; it is focused on parts different from those in the first configuration example and described.

The second configuration example in FIG. 12 is different in that an image synthesis unit 81 is newly added on a subsequent stage of the distance image/reliability calculation unit 61, and the configuration other than this is similar to that in the first configuration example.

The signal processing unit 15 according to the second configuration example sets the light emission amount p as the exposure control parameter two times (high luminance and low luminance) in the light emission control unit 13, and generates a depth map obtained by synthesizing a first depth map generated under a high luminance environment and a second depth map generated under a low luminance environment to output. As for the reliability map, similarly, a reliability map obtained by synthesizing a first reliability map generated under a high luminance environment and a second reliability map generated under a low luminance environment is generated and output.

In the ToF sensor, there is a problem that, when light emission is increased so that information at a long distance may be obtained, electric charge saturation occurs at an object at a short distance and information cannot be obtained; and conversely, when light emission is decreased, sufficient light does not reach an object at a long distance and an SN ratio cannot be obtained. The above-described problem may be solved by setting the light emission amount p of the light source two times (high luminance and low luminance) and synthesizing a plurality of depth maps.

For example, when generating the first depth map, the parameter determination unit 65 supplies the exposure control parameter including a first light emission amount P_{low} of low luminance to the light emission control unit 13. The light emission unit 12 emits light with the first light emission amount P_{low}, and the light reception unit 14 outputs the pixel data corresponding to the light reception amount to the distance image/reliability calculation unit 61. The distance image/reliability calculation unit 61 generates the first depth map and the first reliability map at the time of low luminance on the basis of the pixel data of each pixel 21.

Next, when generating the second depth map, the parameter determination unit 65 supplies the exposure control parameter including a second light emission amount P_{high} of high luminance to the light emission control unit 13. The light emission unit 12 emits light with the second light emission amount P_{high}, and the light reception unit 14 outputs the pixel data corresponding to the light reception amount to the distance image/reliability calculation unit 61. The distance image/reliability calculation unit 61 generates the second depth map and the second reliability map at the time of high luminance on the basis of the pixel data of each pixel 21.

The image synthesis unit 81 performs synthesis processing of the first depth map at the time of low luminance and the second depth map at the time of high luminance to generate a depth map in which a dynamic range is expanded (hereinafter, referred to as an HDR depth map). Furthermore, the image synthesis unit 81 performs synthesis processing of the first reliability map at the time of low luminance and the second reliability map at the time of high luminance to generate a reliability map in which a dynamic range is expanded (hereinafter, referred to as an HDR reliability map). The generated HDR depth map and HDR reliability map are output to the outside and supplied to the statistic calculation unit 62.

A luminance value 1_{hdr} in a case where a luminance value 1 (r,p_{low}, t,d) with the first light emission amount P_{low} and a luminance value l (r,p_{high},t,d) with the second light emission amount phi_{g}h are synthesized may be expressed by following expression (11).

l_{hdr}=α·r·l(r, p_{low}, t, d)+(1−α)·l(r, P_{high}, t, d) (11)

In expression (11), r represents a luminance ratio (r=p_{high}/p_{low}) between the first light emission amount p_{low} and the second light emission amount p_{high}, and α represents a blend ratio (0≤α≤1) of the first depth map at the time of low luminance and the second depth map at the time of high luminance.

The blend ratio α may be determined by the reliability cnf corresponding to the luminance value. Since magnitude of noise may be assumed by a level of the reliability cnf, for example, it is possible to set to use, in a case where the reliability cnf is smaller than a first threshold TH1, only the luminance value l (r,p_{low},t,d) with the first light emission amount p_{low} while setting α=1, and use, in a case where the reliability cnf is equal to or larger than the first threshold TH1, only the luminance value l (r,p_{high},t,d) with the second light emission amount p_{high} while setting α=0. Therefore, the electric charge saturation does not occur even when the object as the subject is at a short distance, and the pixel data with a sufficient light amount may be obtained even when the object is at a long distance, so that it is possible to perform ranging of a wide range from near to far.

The synthesis of the HDR depth map by the image synthesis unit 81 may also be performed by blend processing similar to expression (11). The same applies to the synthesis of the HDR reliability map.

The statistic calculation unit 62 calculates a statistic of the HDR depth map from one HDR depth map supplied from the distance image/reliability calculation unit 61. That is, as in the first configuration example, a histogram of the distance d for the HDR depth map is generated.

The evaluation value calculation unit 63 calculates the evaluation value E with the current exposure control parameter according to the evaluation index supplied from the evaluation index storage unit 64. An expression for obtaining the evaluation value E supplied from the evaluation index storage unit 64 is the same as expression (10) described above. That is, the evaluation value E is expressed by the expression in which the appearance frequency p(d) of the distance d and the SNR(d) corresponding to the distance d are convoluted.

Note that the SNR(d) that is the SN ratio corresponding to the distance d in a case where two depth images at the time of high luminance and low luminance are synthesized with the blend ratio α is defined by following expression (12), and further expressed as expression (12)′ in consideration of saturation at a short distance.

$$\begin{matrix}[ Mathematical Expression 8 ] & \\ SNR ( d ) = \frac{α \cdot r \cdot {l}_{low} + ( 1 - α ) \cdot {l}_{high}}{α \cdot r \sqrt{{σ}^{2} ( {l}_{low} )} + ( 1 - α ) \sqrt{{σ}^{2} ( {l}_{high} )}} & ( 12 )\end{matrix}$$

$$SNR ( d ) = \{ \begin{matrix}0 & if l ( r , p , t , d ) is Satulated \\ \frac{α \cdot r \cdot {l}_{low} + ( 1 - α ) \cdot {l}_{high}}{\begin{matrix}α \cdot r \sqrt{{σ}^{2} ( {l}_{low} )} + \\ ( 1 - α ) \sqrt{{σ}^{2} ( {l}_{high} )}\end{matrix}} & otherwise\end{matrix} \qquad {( 12 )}^{′}$$

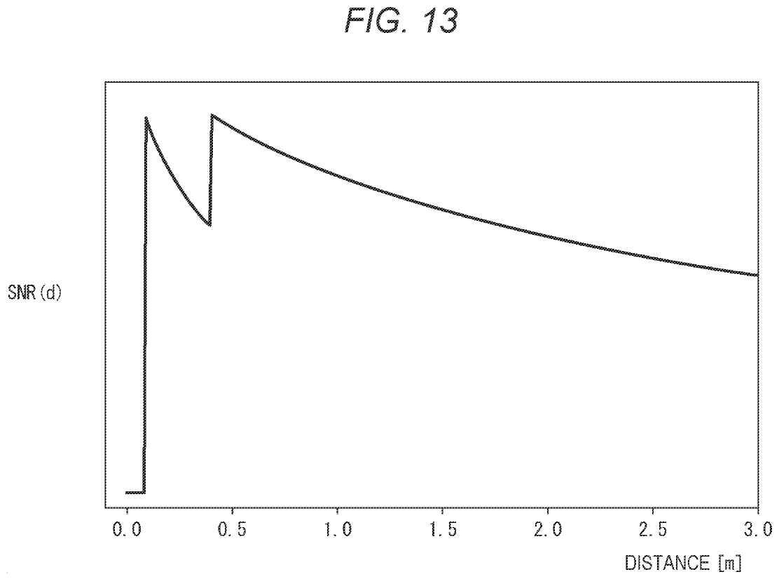

FIG. 13 illustrates an example of the SNR(d) of expression (12)′.

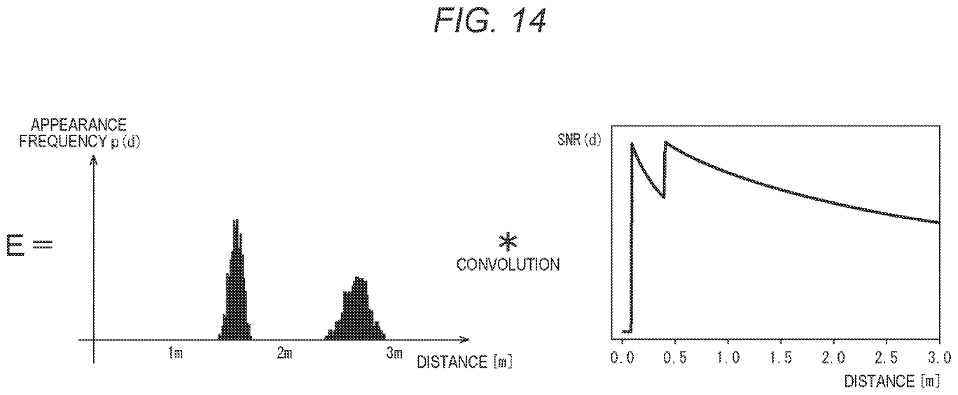

FIG. 14 is a conceptual diagram corresponding to expression (10) for obtaining the evaluation value E using the SNR(d) in FIG. 13.

A plurality of SNRs(d) is stored in the evaluation index storage unit 64, and the evaluation value calculation unit 63 obtains a predetermined SNR(d) from the evaluation index storage unit 64 according to an operation mode, a reflectance r of a measurement target, a ranging range and the like.

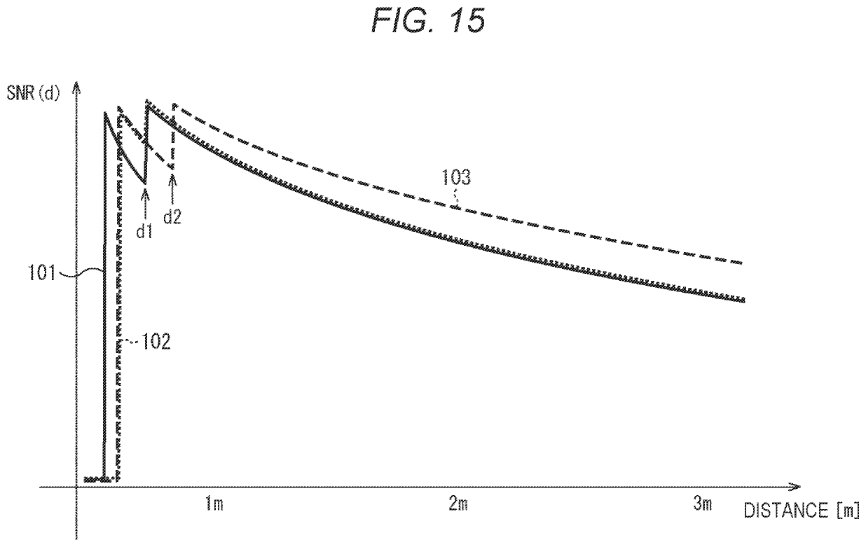

FIG. 15 illustrates an example of a plurality of SNRs d) stored in the evaluation index storage unit 64.

The evaluation index storage unit 64 stores three types of SNRs(d) of SNRs 101 to 103.

In the SNR 101, the SNR with the first light emission amount p_{low} for short distance and the SNR with the second light emission amount p_{high} for long distance are switched at a distance d1.

In the SNR 102, the SNR for short distance and the SNR for long distance are switched at the distance d1 as is the case with the SNR 101; however, a measurement range of the SNR with the first light emission amount p_{low} for short distance is narrower than that of the SNR 101 but is set at a high SN ratio.

In the SNR 103, a distance d2 at which the SNR for short distance and the SNR for long distance are switched is set to be longer than the distance d1 of the SNRs 101 and 102 (d1<d2), and the measurement range of the SNR for short distance is set to be larger than that of the SNR 102.

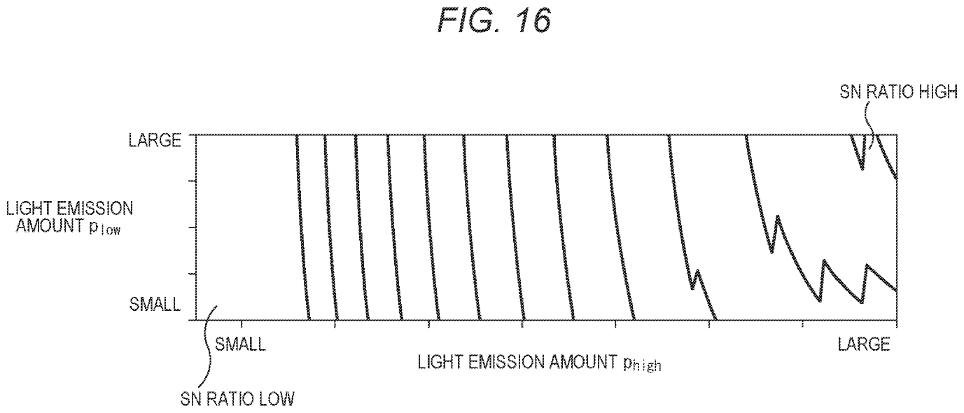

FIG. 16 illustrates contour lines of the SNR in a two-dimensional region in which the second light emission amount p_{high} for long distance is plotted along a horizontal axis and the first light emission amount p_{low} for short distance is plotted along a vertical axis.

Since the SNR becomes higher as the light emission amount is larger, the SNR is the highest in upper right of the two-dimensional region in FIG. 16, that is, in a case where both the first light emission amount p_{low} and the second light emission amount p_{high} are large, and the SNR is the lowest in lower left of the two-dimensional region in FIG. 16, that is, in a case where both the first light emission amount p_{low} and the second light emission amount P_{high} are small. The parameter determination unit 65 sequentially updates the exposure control parameter, and searches for the exposure control parameter with which the SNR is the highest to determine.

### 7. Second Depth Map Generation Processing

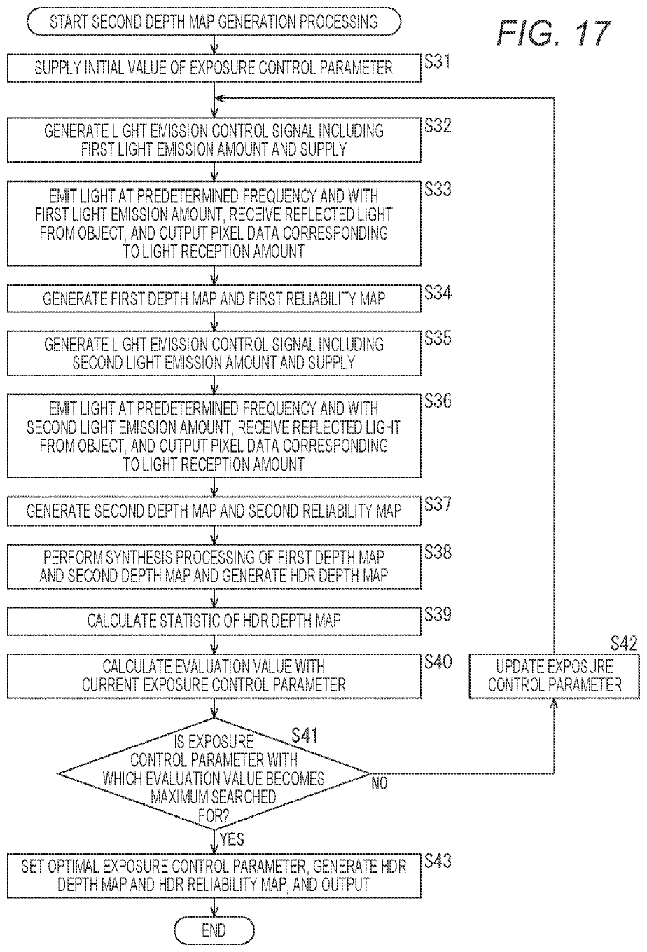

Next, depth map generation processing (second depth map generation processing) by the ranging module 11 having the second configuration example of the signal processing unit 15 is described with reference to a flowchart in FIG. 17. This processing is started, for example, when an instruction to start ranging is supplied to the ranging module 11.

First, at step S31, the parameter determination unit 65 supplies an initial value of the exposure control parameter determined in advance to the light emission control unit 13. Here, the exposure control parameter supplied to the light emission control unit 13 includes at least two types of light emission amounts p of the first light emission amount p_{low} for short distance and the second light emission amount p_{high} for long distance.

At step S32, the light emission control unit 13 generates the light emission control signal including the first light emission amount p_{low} on the basis of the exposure control parameter supplied from the parameter determination unit 65, and supplies the same to the light emission unit 12 and the light reception unit 14.

At step S33, the light emission unit 12 emits light at a predetermined frequency and with the first light emission amount p_{low} based on the light emission control signal, and the light reception unit 14 receives the reflected light from the object. Then, each pixel 21 of the light reception unit 14 outputs the pixel data generated according to the light reception amount to the distance image/reliability calculation unit 61 of the signal processing unit 15. The light reception unit 14 receives light in four phases shifted by 0°, 90°, 180°, and 270° with respect to the light emission timing of the irradiation light, and outputs the pixel data obtained as a result to the distance image/reliability calculation unit 61.

At step S34, the distance image/reliability calculation unit 61 generates the first depth map and the first reliability map on the basis of the pixel data of each pixel 21 supplied from the light reception unit 14, and supplies the same to the statistic calculation unit 62.

At step S35, the light emission control unit 13 generates the light emission control signal including the second light emission amount p_{high}, and supplies the same to the light emission unit 12 and the light reception unit 14.

At step S36, the light emission unit 12 emits light at a predetermined frequency and with the second light emission amount p_{high} based on the light emission control signal, and the light reception unit 14 receives the reflected light from the object. Then, each pixel 21 of the light reception unit 14 outputs the pixel data generated according to the light reception amount to the distance image/reliability calculation unit 61 of the signal processing unit 15. The light reception unit 14 receives light in four phases shifted by 0°, 90°, 180°, and 270° with respect to the light emission timing of the irradiation light, and outputs the pixel data obtained as a result to the distance image/reliability calculation unit 61.

At step S37, the distance image/reliability calculation unit 61 generates the second depth map and the second reliability map on the basis of the pixel data of each pixel 21 supplied from the light reception unit 14, and supplies the same to the statistic calculation unit 62.

At step S38, the image synthesis unit 81 performs the synthesis processing of the first depth map at the time of low luminance and the second depth map at the time of high luminance to generate the HDR depth map in which the dynamic range is expanded. Furthermore, the image synthesis unit 81 performs the synthesis processing of the first reliability map at the time of low luminance and the second reliability map at the time of high luminance to generate the HDR reliability map in which the dynamic range is expanded. The generated HDR depth map and HDR reliability map are output to the outside and supplied to the statistic calculation unit 62.

At step S39, the statistic calculation unit 62 calculates the statistic of the HDR depth map from one HDR depth map supplied from the distance image/reliability calculation unit 61. That is, the statistic calculation unit 62 generates the histogram of the distance d for the HDR depth map and supplies the same to the evaluation value calculation unit 63.

At step S40, the evaluation value calculation unit 63 calculates the evaluation value E with the current exposure control parameter according to the evaluation index supplied by the evaluation index storage unit 64. Specifically, the evaluation value calculation unit 63 calculates the evaluation value E of expression (10) supplied from the evaluation index storage unit 64 as the evaluation index, and supplies a result thereof to the parameter determination unit 65.

At step S41, the parameter determination unit 65 determines whether or not the exposure control parameter with which the evaluation value E becomes maximum is searched for. This determination processing is similar to that at step S17 in FIG. 11 described above.

In a case where it is determined at step S41 that the exposure control parameter with which the evaluation value E becomes maximum is not yet searched for, the procedure shifts to step S42, and the parameter determination unit 65 updates the exposure control parameter and supplies the same to the light emission control unit 13. After step S2, the procedure returns to step S32, and the processes at steps S32 to S41 described above are repeated.

Then, in a case where it is determined at step S41 that the exposure control parameter with which the evaluation value E becomes maximum is searched for, the procedure shifts to step S43. The exposure control parameter with which the evaluation value E becomes maximum is the optimal exposure control parameter.

At step S43, the ranging module 11 sets the optimal exposure control parameter, generates the HDR depth map and the HDR reliability map on the basis of the received reflected light, and outputs the same to the outside. That is, the ranging module 11 generates two depth maps and reliability maps by two types of light emission amounts p of the first light emission amount p_{low} for short distance and the second light emission amount p_{high} for long distance determined as the optimal exposure control parameter, performs the synthesis processing, generates the DR depth map and the HDR reliability map, and outputs the same to the outside.

Then, the second depth map generation processing is finished.

According to the second depth map generation processing, by receiving the reflected light while setting the light emission amount of the light source two times (low luminance and high luminance), it is possible to obtain the distance information of the object from the short distance to the long distance using the two depth maps of the first depth map at the time of low luminance and the second depth map at the time of high luminance. In the light reception of two times also, the exposure control parameter that maximizes the evaluation index is searched for on the basis of the evaluation index using the luminance information assumed according to the distance and the distance information of the object (subject) obtained by actually receiving the reflected light to be determined. Therefore, appropriate exposure control may be performed.

### 8. Third Configuration Example of Signal Processing Unit

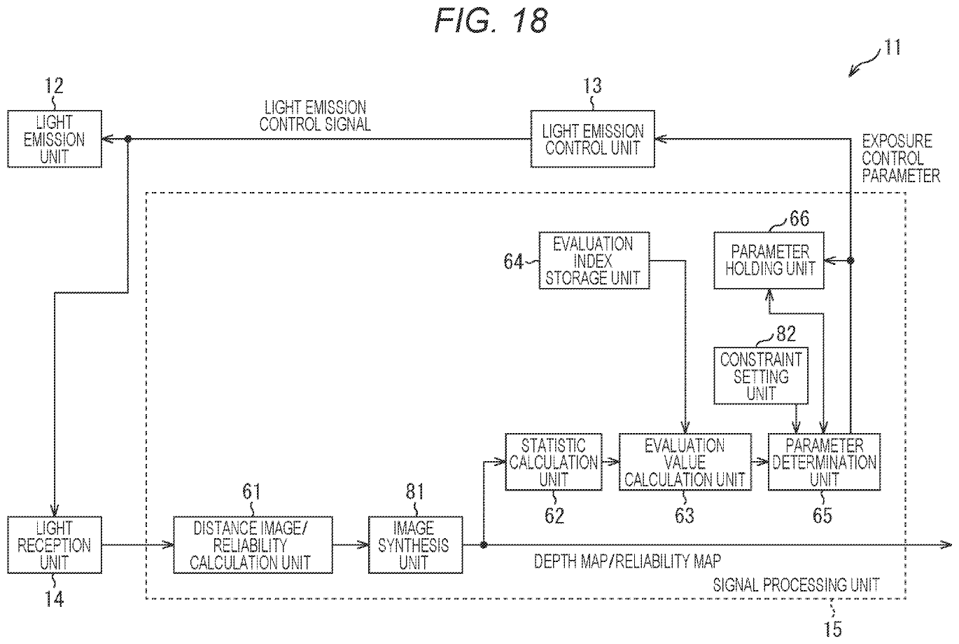

FIG. 18 is a block diagram illustrating a third configuration example of the signal processing unit 15. FIG. 18 also illustrates the configuration other than this of the ranging module 11.

In the third configuration example in FIG. 18, parts corresponding to those in the second configuration example illustrated in FIG. 12 are assigned with the same reference signs and description thereof is omitted as appropriate; it is focused on parts different from those in the second configuration example and described.

The third configuration example in FIG. 18 is different in that a constraint setting unit 82 is newly added, and the configuration other than this is similar to that in the second configuration example.

In the second depth map generation processing according to the second configuration example described above, the signal processing unit 15 searches for the exposure control parameter with which the evaluation value E becomes maximum. However, as is apparent from the contour lines of the SNR illustrated in FIG. 16, as the first light emission amount p_{low} and the second light emission amount p_{high} are made larger, the SNR becomes higher, so that power consumption of the exposure control parameter with which the evaluation value E becomes maximum also becomes larger. Therefore, it is desirable to determine the optimal exposure control parameter in consideration of the power consumption.

The constraint setting unit 82 newly added in the third configuration example in FIG. 18 sets a constraint condition when determining the optimal exposure control parameter in the parameter determination unit 65. The constraint setting unit 82 sets, as the constraint condition, a lowest value of the SNR (hereinafter, referred to as a lowest SNR) that the ranging module 11 should satisfy in the ranging. The lowest SNR as the constraint condition is determined in advance to be stored by a designer of the ranging module 11, or determined by a user who uses an application on a setting screen of the application using the ranging module 11, for example.

The parameter determination unit 65 sequentially changes the exposure control parameter, and determines the exposure control parameter satisfying the lowest SNR set by the constraint setting unit 82 with which the evaluation value E becomes maximum.

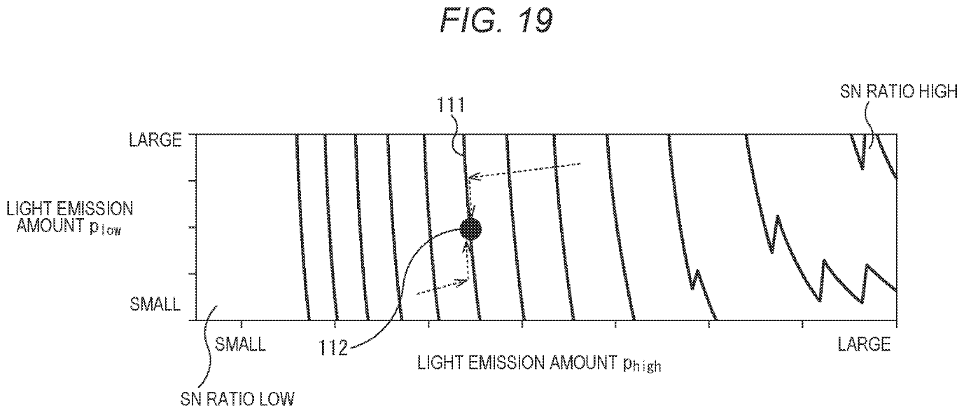

For example, assuming that the lowest SNR determined by the constraint setting unit 82 is set to the SNR indicated by an SNR contour line 111 in FIG. 19, first, the exposure control parameter that matches the SNR of the SNR contour line 111 is sequentially updated from a predetermined initial value to be searched for, and then a combination 112 of the first light emission amount p_{low} and the second light emission amount p_{high} with which the power consumption is the smallest is determined out of the SNRs on the SNR contour line 111.

### 9. Third Depth Map Generation Processing

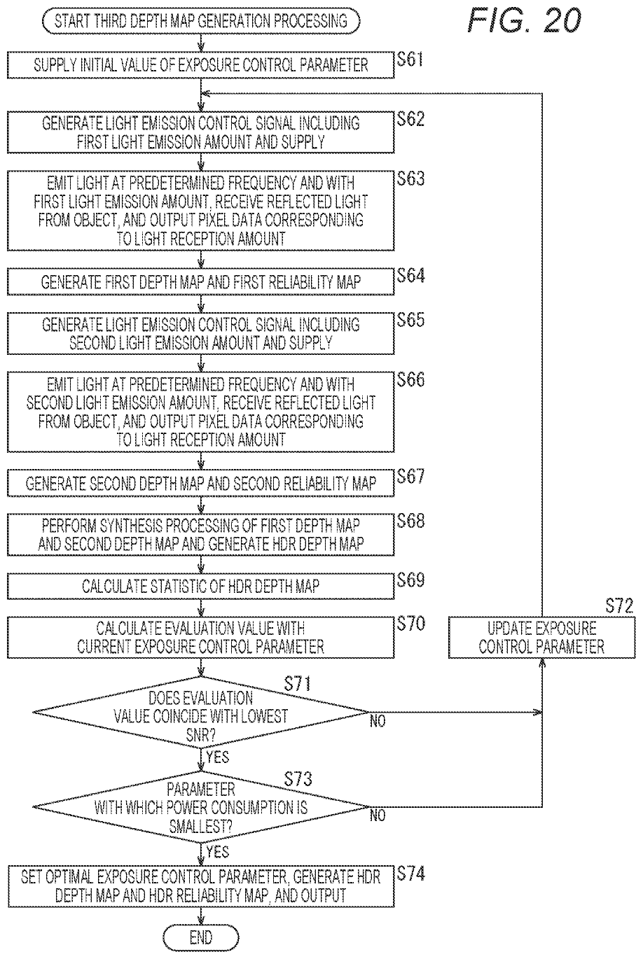

Next, depth map generation processing (third depth map generation processing) by the ranging module 11 having the third configuration example of the signal processing unit 15 is described with reference to a flowchart in FIG. 20. This processing is started, for example, when an instruction to start ranging is supplied to the ranging module 11.

Since steps S61 to S70 in FIG. 20 are similar to steps S31 to S40 of the second depth map generation processing illustrated in FIG. 17, the description thereof is omitted.

After the evaluation value E with the current exposure control parameter is calculated at step S70, at step S71, the parameter determination unit 65 determines whether the evaluation value E calculated by the evaluation value calculation unit 63 matches the lowest SNR as the constraint condition. In a case where the calculated evaluation value E falls within a predetermined range close to the lowest SNR that is a target value, the parameter determination unit 65 determines that this matches the lowest SNR. The lowest SNR as the constraint condition is supplied from the constraint setting unit 82 before the depth map generation processing or as necessary.

In a case where it is determined at step S71 that the evaluation value with the current exposure control parameter does not match the lowest SNR, the procedure shifts to step 72, and the parameter determination unit 65 updates the exposure control parameter and supplies the same to the light emission control unit 13. After step S72, the procedure returns to step S62, and the processes at steps S62 to S71 described above are repeated.

Then, in a case where it is determined that the evaluation value with the current exposure control parameter matches the lowest SNR, the procedure shifts to step S73. At step S73, the parameter determination unit 65 determines whether or not the current exposure control parameter is the exposure control parameter with which the power consumption is the smallest. Here, since the two types of light emission amounts p of the first light emission amount p_{low} for short distance and the second light emission amount p_{high} for long distance are changed as processing of searching for the exposure control parameter, the power consumption at step S73 may be simply considered as the sum of the first light emission amount p_{low} and the second light emission amount p_{high}.

In a case where it is determined at step S73 that the current exposure control parameter is not the exposure control parameter with which the power consumption is the smallest, the procedure shifts to step S72, the exposure control parameter is changed to a next value, and the processes at steps S62 to S73 described above are repeated.

In contrast, in a case where it is determined at step S73 that the current exposure control parameter is the exposure control parameter with which the power consumption is the smallest, the procedure shifts to step S74. That is, in a case where the exposure control parameter satisfying the constraint condition with which the evaluation value E becomes maximum is determined, the procedure shifts to step S74.

At step S74, the ranging module 11 sets the optimal exposure control parameter, generates the HDR depth map and the HDR reliability map on the basis of the received reflected light, and outputs the same to the outside. That is, the ranging module 11 generates the two depth maps and reliability maps by the two types of light emission amounts p of the first light emission amount p_{low} for short distance and the second light emission amount p_{high}, for long distance determined as the optimal exposure control parameter, performs the synthesis processing, generates the HDR depth map and the HDR reliability map, and outputs the same to the outside.

Then, the third depth map generation processing is finished.

According to the third depth map generation processing, it is possible to determine the optimal exposure control parameter in consideration of the power consumption.

Note that, in the third depth map generation processing described above, the processing of first searching for the exposure control parameter that matches the lowest SNR and then searching for the exposure control parameter with which the power consumption is the smallest is executed; however, it is possible to search for the exposure control parameter with which both the lowest SNR and the smallest power consumption are satisfied simultaneously.

### 10. Fourth Configuration Example of Signal Processing Unit

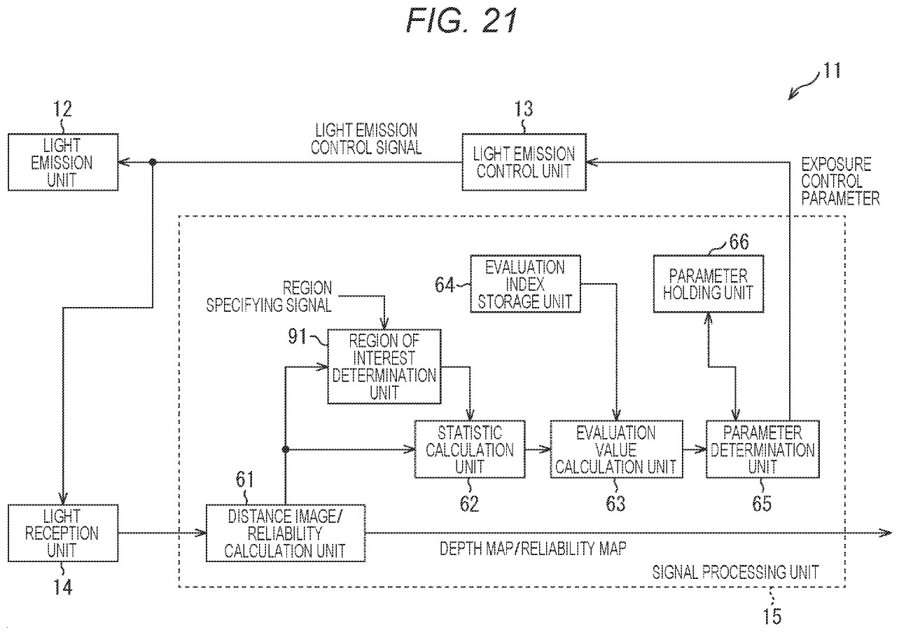

FIG. 21 is a block diagram illustrating a fourth configuration example of the signal processing unit 15. FIG. 21 also illustrates the configuration other than this of the ranging module 11.

In the fourth configuration example in FIG. 21, parts corresponding to those of the first configuration example illustrated in FIG. 10 are assigned with the same reference numerals and description thereof is omitted as appropriate; it is focused on parts different from those in the first configuration example and described.

The fourth configuration example in FIG. 21 is different in that a region of interest determination unit 91 is newly added, and the configuration other than this is similar to that in the first configuration example illustrated in FIG. 10.

As is the case with the first configuration example described above, the signal processing unit 15 according to the fourth configuration example determines the exposure control parameter with which the evaluation value E becomes maximum as the optimal exposure control parameter; however, this determines the exposure control parameter with which the evaluation value E becomes maximum not for an entire pixel region of the pixel array unit 22 but for a region of interest especially focused on in the entire pixel region as the optimal exposure control parameter.

The depth map and the reliability map are supplied from the distance image/reliability calculation unit 61 to the region of interest determination unit 91. The region of interest determination unit 91 determines the region of interest in the entire pixel region of the pixel array unit 22 using at least one of the depth map or the reliability map, and supplies region setting information for setting the region of interest to the statistic calculation unit 62. A method by which the region of interest determination unit 91 determines the region of interest is not especially limited. For example, the region of interest determination unit 91 may discriminate a region for each object as a cluster from the distance information indicated by the depth map or the luminance information indicated by the reliability map, and determine the cluster the closest to a recognition target registered in advance as the region of interest. Furthermore, for example, the region of interest determination unit 91 may discriminate a region for each object as a cluster from the luminance information indicated by the reliability map, and determine the cluster having the highest reliability as the region of interest. The region of interest determination unit 91 may determine the region of interest from an object recognition result by an object recognizer by using an arbitrary object recognizer.

Moreover, the region of interest determination unit 91 may also determine the region of interest on the basis of a region specifying signal supplied from a device outside the ranging module 11. For example, when the user performs an operation on a touch panel of a smartphone and the like in which the ranging module 11 is incorporated, the region of interest is set by the user, and the region specifying signal indicating the region of interest is supplied to the region of interest determination unit 91. The region of interest determination unit 91 supplies the region setting information indicating the region of interest determined on the basis of the region specifying signal to the statistic calculation unit 62.

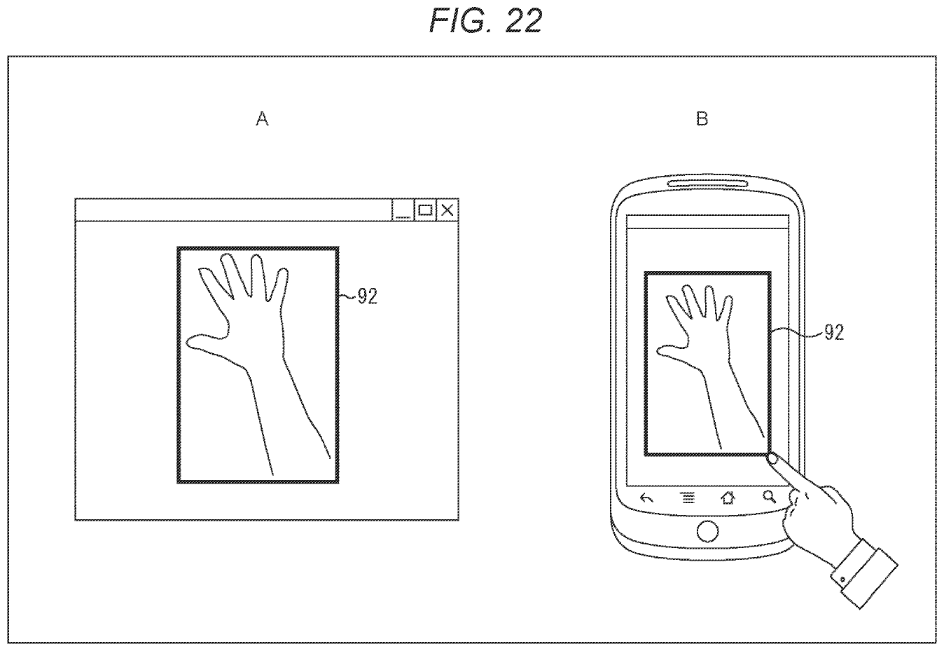

A of FIG. 22 illustrates a state in which a region of interest 92 is set by automatic recognition processing using the depth map or the reliability map.

B of FIG. 22 illustrates a state in which the region of interest 92 is set by the user designating the region of interest 92 on the touch panel of the smartphone.

The statistic calculation unit 62 calculates the statistic of the depth map regarding the region of interest from one depth map supplied from the distance image/reliability calculation unit 61 and the region setting information of the region of interest supplied from the region of interest determination unit 91. Specifically, the statistic calculation unit 62 generates a histogram of the distance d obtained by counting the appearance frequency (frequency) of the distance d for the pixels of the region of interest illustrated in FIG. 8, and supplies the same to the evaluation value calculation unit 63.

The evaluation value calculation unit 63 calculates the evaluation value E for the region of interest and supplies the same to the parameter determination unit 65.

### 11. Fourth Depth Map Generation Processing

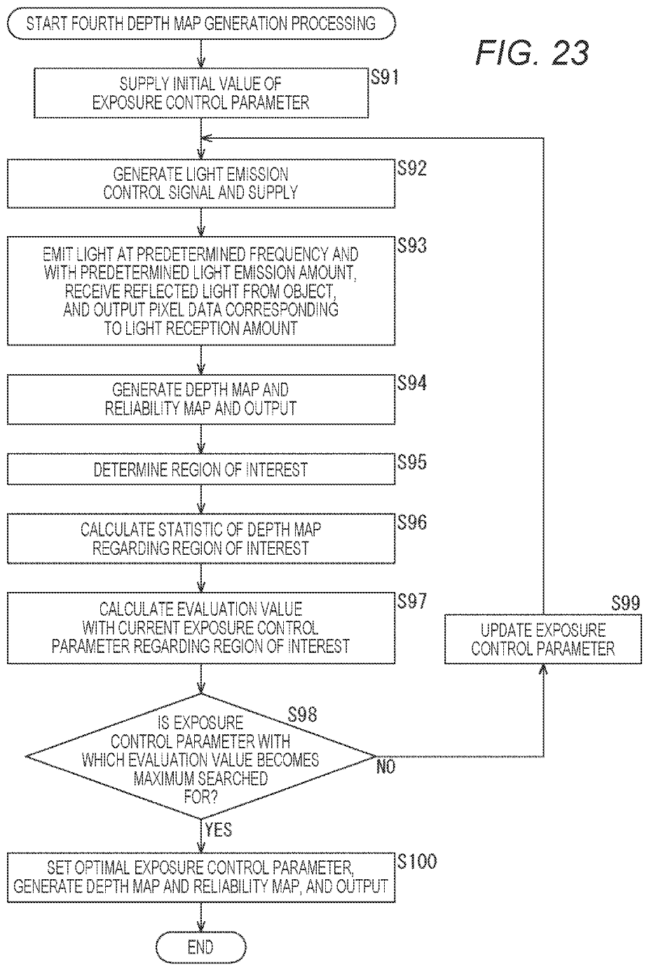

Next, depth map generation processing (fourth depth map generation processing) by the ranging module 11 having the fourth configuration example of the signal processing unit 15 is described with reference to a flowchart in FIG. 23. This processing is started, for example, when an instruction to start ranging is supplied to the ranging module 11.

Steps S91 to S94 in FIG. 23 are similar to steps S11 to S14 of the first depth map generation processing illustrated in FIG. 11. By the processing up to step S94, the depth map and the reliability map generated by the distance image/reliability calculation unit 61 are supplied to the statistic calculation unit 62 and the region of interest determination unit 91.

At step S95, the region of interest determination unit 91 determines the region of interest in the entire pixel region for which the depth map and the reliability map are generated. In a case where the region of interest determination unit 91 itself discriminates the region of interest, for example, the region of interest determination unit 91 discriminates a region for each object as a cluster from the distance information indicated by the depth map or the luminance information indicated by the reliability map, and determines the cluster the closest to a recognition target registered in advance as the region of interest. In a case where the region of interest is set outside the ranging module 11, the region of interest determination unit 91 determines the region of interest on the basis of the input region specifying signal. The region setting information for setting the determined region of interest is supplied to the statistic calculation unit 62.

At step S96, the statistic calculation unit 62 calculates the statistic of the depth map regarding the region of interest from one depth map supplied from the distance image/reliability calculation unit 61 and the region setting information indicating the region of interest supplied from the region of interest determination unit 91.

At step S97, the evaluation value calculation unit 63 calculates the evaluation value E with the current exposure control parameter for the region of interest. This process is similar to that at step S16 in FIG. 11 except that the evaluation value E is calculated for the region of interest.

The processes at steps S98 to S100 are similar to those at steps S17 to S19 of the first depth map generation processing illustrated in FIG. 11. That is, the processing is repeated until it is determined that the optimal exposure control parameter with which the evaluation value E becomes the maximum is searched for on the basis of the evaluation value E of the region of interest, and the depth map and the reliability map are generated by the determined optimal exposure control parameter to be output to the outside.

Then, the fourth depth map generation processing is finished.

According to the fourth depth map generation processing, it is possible to search for the exposure control parameter that maximizes the evaluation index not for an entire light reception region of the ranging module 11 but for a partial region thereof to determine. Therefore, it is possible to perform appropriate exposure control specialized for the partial region of the light reception region.

Note that the fourth configuration example in FIG. 21 is a configuration obtained by adding the region of interest determination unit 91 to the first configuration example illustrated in FIG. 10; a configuration obtained by adding the region of interest determination unit 91 to the second configuration example illustrated in FIG. 12 and the third configuration example illustrated in FIG. 18 is also possible. In other words, it is possible to set the region of interest for the HDR depth map and the HDR reliability map generated using the two depth maps of the first depth map at the time of low luminance and the second depth map at the time of high luminance, and obtain an appropriate exposure control parameter.

### 12. First Variation

<Control to Change Light Emission Frequency>

In the example described above, a light emission unit 12 irradiates an object with modulated light at a single frequency of 20 MHz and the like, for example, on the basis of a light emission control signal. When a modulation frequency of a light source is made higher to, for example, 100 MHz and the like, resolution of distance information may be increased, but a range in which ranging may be performed is narrowed. In contrast, when the modulation frequency is made lower, the range in which the ranging may be performed may be expanded.

A distance d is expressed by expression (1) as described above, and the distance information is calculated on the basis of a phase shift amount φ of reflected light. At that time, when noise occurring in the phase shift amount φ is a function σ_{φ}(1) of a luminance value l, noise σ_{d} superimposed on the distance d may be defined as following expression (13) from expression (1).

$$\begin{matrix}[ Mathematical Expression 9 ] & \\ {σ}_{d} = \frac{c \cdot {σ}_{ϕ} ( l )}{4 π f} = \frac{k \cdot {σ}_{ϕ} ( l )}{f} & ( 13 )\end{matrix}$$

Here, k in expression (13) represents a constant satisfying k=c/4π.

As is clear from expression (13), the higher the modulation frequency, the smaller an error (noise) of the distance d. Therefore, as a first variation of a signal processing unit 15, it is possible to configure such that an exposure control parameter supplied from a parameter determination unit 65 to a light emission control unit 13 includes a modulation frequency f in addition to an exposure time t and a light emission amount p, and an optimal exposure control parameter including the modulation frequency f is determined.

Specifically, a ranging module 11 first irradiates the object with irradiation light at a first frequency of 20 MHz and the like, for example, to execute depth map generation processing, and, in a case where it is determined that a distance to a measurement target is short (the distance to the measurement target falls within a predetermined range) as a result of the depth map generation processing, executes the depth map generation processing while changing the modulation frequency to a second frequency higher than the first frequency, for example, 100 MHz. In this case, a depth map and a reliability map generated by a distance image/reliability calculation unit 61 are supplied also to the parameter determination unit 65, and the parameter determination unit 65 supplies the exposure control parameter changed to the second frequency according to the distance to the measurement target to the light emission control unit 13.

In addition to a two-stage parameter searching method of determining an optimal value of the light emission amount p and then determining an optimal value of the modulation frequency f as described above, it is also possible to employ a method in which expressions of SNR(d) of expressions (9) and (12) include both the light emission amount p and the modulation frequency f, and the optimal values of the light emission amount p and the modulation frequency f with which an evaluation value E of expression (10) becomes maximum are simultaneously determined.

The first variation to determine the exposure control parameter including the modulation frequency may be executed in combination with any of the first to fourth configuration examples described above.

### 13. Second Variation

<Control to Change Exposure Time>

In the first depth map generation processing to the fourth depth map generation processing described above, a signal processing unit 15 changes a light emission amount p as an exposure control parameter and determines an optimal value of the light emission amount p.

Signal electric charges generated in a light reception unit 14 change by an increase in the light emission amount p, but it is also possible to increase the signal electric charges by changing an exposure time t with the light emission amount p fixed. That is, a change in luminance due to a change in the light emission amount p is essentially the same as the change in the exposure time t. Therefore, instead of changing the light emission amount p in the first depth map generation processing to the fourth depth map generation processing described above, processing may control to change the exposure time t and determine an optimal value of the exposure time t as the exposure control parameter.

Note that, when the exposure time t is made longer, a frame rate might decrease. In this case, for example, a constraint setting unit 82 in a third configuration example of the signal processing unit 15 illustrated in FIG. 18 may set a lower limit value of the frame rate as a constraint condition. Therefore, it is possible to determine the exposure control parameter satisfying the lower limit value of the frame rate set by the constraint setting unit 82 with which an evaluation value E becomes maximum.

### 14. Third Variation

<Control in Consideration of Ambient Light>

Components of pixel data (detection signal) obtained in each pixel 21 of a light reception unit 14 are roughly divided into active components, ambient light components, and noise components. The active components are light components of irradiation light reflected by an object to be returned. The ambient light components are light components due to ambient light such as sunlight. Although the ambient light components are canceled in the course of arithmetic operations of expressions (3) to (5) described above, the noise components remain, so that as the ambient light components increase, a rate of the noise components increases, and an SN ratio relatively decreases.

Therefore, in a case where it is determined that a rate of the ambient light components is large, a signal processing unit 15 may perform processing of generating an exposure control parameter to shorten an exposure time t and increase a light emission amount p, and supplying the same to the light emission control unit 13. The rate of the ambient light components may be determined, for example, from a difference between a mean value of the pixel data (detection signals) obtained by the respective pixels 21 and a mean value of reliabilities of the respective pixels calculated from a reliability map supplied from a distance image/reliability calculation unit 61. Alternatively, the rate of the ambient light components may be simply determined by (magnitude of) the mean value of the reliabilities of the respective pixels calculated from the reliability map.

Specifically, a parameter determination unit 65 obtains the pixel data of each pixel 21 from the light reception unit 14, and obtains the reliability map from the distance image/reliability calculation unit 61. Then, the parameter determination unit 65 determines whether or not the rate of the ambient light components is large, and in a case where it is determined that the rate of the ambient light components is large, this may generate the exposure control parameter to shorten the exposure time t and increase the light emission amount p.

Therefore, an influence of an increase in noise may be reduced by increasing the rate of the active components.

### 15. Summary

The ranging module 11 in FIG. 1 may include the first to fourth configuration examples or variations thereof of the signal processing unit 15, and may execute the first depth map generation processing to the fourth depth map generation processing and processing according to the variations thereof. The ranging module 11 may be configured to execute only one of the first depth map generation processing to the fourth depth map generation processing and the processing according to the variation thereof, or may be configured to selectively execute all pieces of processing by switching the operation mode and the like.

According to the ranging module 11 in FIG. 1, it is possible to search for the exposure control parameter that maximizes the evaluation index on the basis of the evaluation index using the luminance information assumed according to the distance and the distance information of the object (subject) obtained by actually receiving the reflected light and determine. Therefore, appropriate exposure control may be performed.

Furthermore, it is possible to generate the HDR depth map and the HDR reliability map in which the dynamic range is expanded on the basis of the result of light reception while setting the light emission amount of the light source two times to the low luminance and the high luminance, and it is possible to perform the appropriate exposure control also in such a case.

Since the evaluation index when determining the optimal exposure control parameter may be defined in the evaluation index storage unit 64, the designer of the ranging module 11, a designer of a ranging application using the ranging module 11, a user of the ranging application or the like may arbitrarily set the evaluation index.

Furthermore, in the configuration in which the constraint setting unit 82 is added, after setting the constraint condition such as the SN ratio, the power consumption, and the frame rate, appropriate exposure control may be performed.

In the configuration in which the region of interest determination unit 91 is added, it is possible to search for the exposure control parameter that maximizes the evaluation index not for an entire light reception region of the ranging module 11 but for a partial region thereof to determine.

### 16. Configuration Example of Electronic Device

The above-described ranging module 11 may be mounted on, for example, an electronic device such as a smartphone, a tablet terminal, a mobile phone, a personal computer, a game machine, a television receiver, a wearable terminal, a digital still camera, a digital video camera and the like.

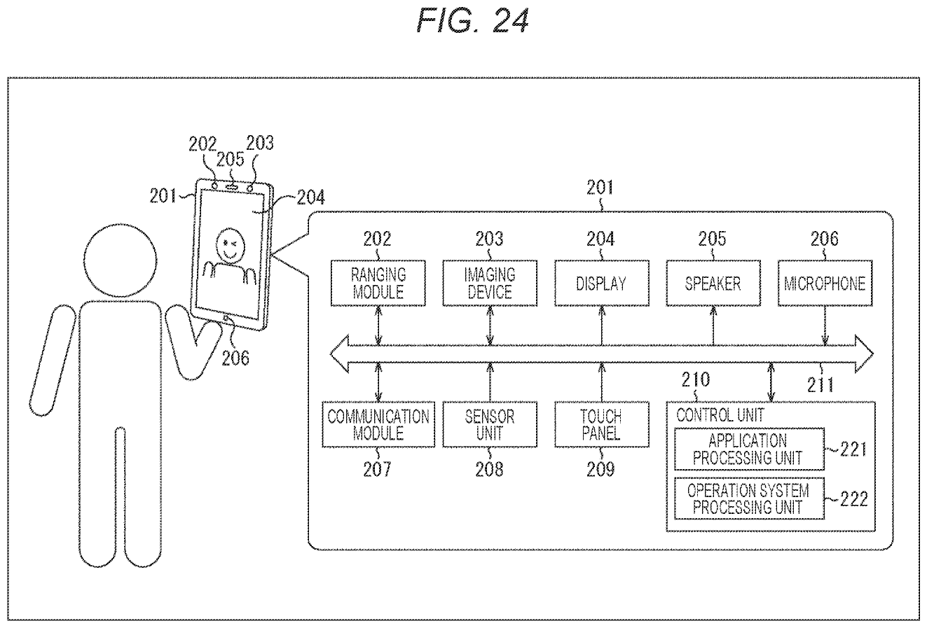

FIG. 24 is a block diagram illustrating a configuration example of a smartphone as an electronic device equipped with a ranging module.

As illustrated in FIG. 24, a smartphone 201 is configured by connecting a ranging module 202, an imaging device 203, a display 204, a speaker 205, a microphone 206, a communication module 207, a sensor unit 208, a touch panel 209, and a control unit 210 via a bus 211. Furthermore, the control unit 210 has functions as an application processing unit 221 and an operation system processing unit 222 by a CPU executing a program.

The ranging module 11 in FIG. 1 is applied to the ranging module 202. For example, the ranging module 202 is arranged on a front surface of the smartphone 201, and may perform ranging on a user of the smartphone 201 to output a depth value of a surface shape of the face, hand, finger and the like of the user as a ranging result.

The imaging device 203 is arranged on the front surface of the smartphone 201, and performs imaging of the user of the smartphone 201 as a subject to obtain an image in which the user is captured. Note that, although not illustrated, the imaging device 203 may also be arranged on a rear surface of the smartphone 201.

The display 204 displays an operation screen for performing processing by the application processing unit 221 and the operation system processing unit 222, the image captured by the imaging device 203 and the like. The speaker 205 and the microphone 206 output a voice of the other party and collect a voice of the user, for example, when talking on the smartphone 201.

The communication module 207 performs communication via a communication network. The sensor unit 208 senses speed, acceleration, proximity and the like, and the touch panel 209 obtains a touch operation by the user on an operation screen displayed on the display 204.

The application processing unit 221 performs processing for providing various services by the smartphone 201. For example, the application processing unit 221 may perform processing of creating a face by computer graphics virtually reproducing an expression of the user on the basis of the depth supplied from the ranging module 202 and displaying the same on the display 204. Furthermore, the application processing unit 221 may perform processing of creating three-dimensional shape data of an arbitrary solid object, for example, on the basis of the depth supplied from the ranging module 202.

The operation system processing unit 222 performs processing for realizing basic functions and operations of the smartphone 201. For example, the operation system processing unit 222 may perform processing of authenticating the face of the user and unlocking the smartphone 201 on the basis of the depth value supplied from the ranging module 202. Furthermore, on the basis of the depth value supplied from the ranging module 202, the operation system processing unit 222 may perform, for example, processing of recognizing a gesture of the user and processing of inputting various operations according to the gesture.

In the smartphone 201 configured in this manner, appropriate exposure control may be performed by applying the above-described ranging module 11. Therefore, the smartphone 201 may more accurately detect ranging information.

### 17. Configuration Example of Computer

Next, a series of processing described above may be performed by hardware or by software. In a case where a series of processing is performed by the software, a program forming the software is installed on a general-purpose computer and the like.

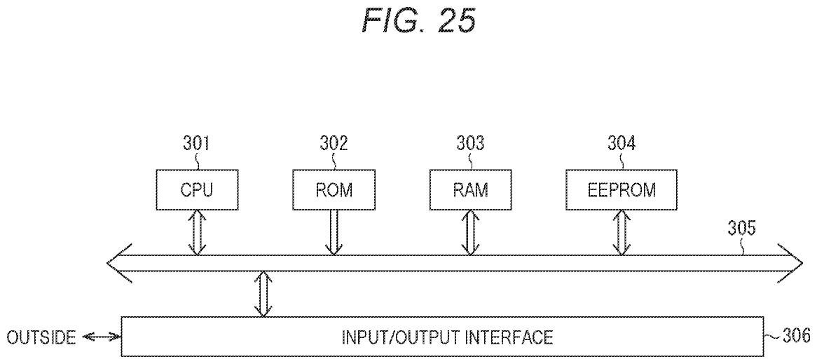

FIG. 25 is a block diagram illustrating a configuration example of one embodiment of a computer on which a program that executes a series of processing described above is installed.

In the computer, a central processing unit (CPU) 301, a read only memory (ROM) 302, a random access memory (RAM) 303, and an electronically erasable and programmable read only memory (EEPROM) 304 are connected to one another by a bus 305. An input/output interface 306 is further connected to the bus 305, and the input/output interface 306 is connected to the outside.

In the computer configured in the above-described manner, the CPU 301 loads the program stored in the ROM 302 and the EEPROM 304, for example, on the RAM 303 via the bus 305 to execute, and thus, the above-described series of processing is performed. Furthermore, the program executed by the computer (CPU 301) may be externally installed on the EEPROM 304 via the input/output interface 306 or updated in addition to be written in the ROM 302 in advance.

Therefore, the CPU 301 performs the processing according to the above-described flowchart or the processing performed by the configuration of the above-described block diagram. Then, the CPU 301 may output a processing result to the outside via the input/output interface 306, for example, as necessary.

Herein, in this specification, the processing performed by the computer according to the program is not necessarily required to be performed in chronological order along the order described as the flowchart. That is, the processing performed by the computer according to the program also includes processing executed in parallel or independently executed processing (for example, parallel processing or processing by an object).

Furthermore, the program may be processed by one computer (processor) or processed in a distributed manner by a plurality of computers. Moreover, the program may be transferred to a remote computer to be executed.

### 18. Application Example to Mobile Body

The technology according to the present disclosure (present technology) may be applied to various products. For example, the technology according to the present disclosure may also be realized as a device mounted on any type of mobile body such as an automobile, an electric automobile, a hybrid electric automobile, a motorcycle, a bicycle, a personal mobility, an airplane, a drone, a ship, a robot and the like.

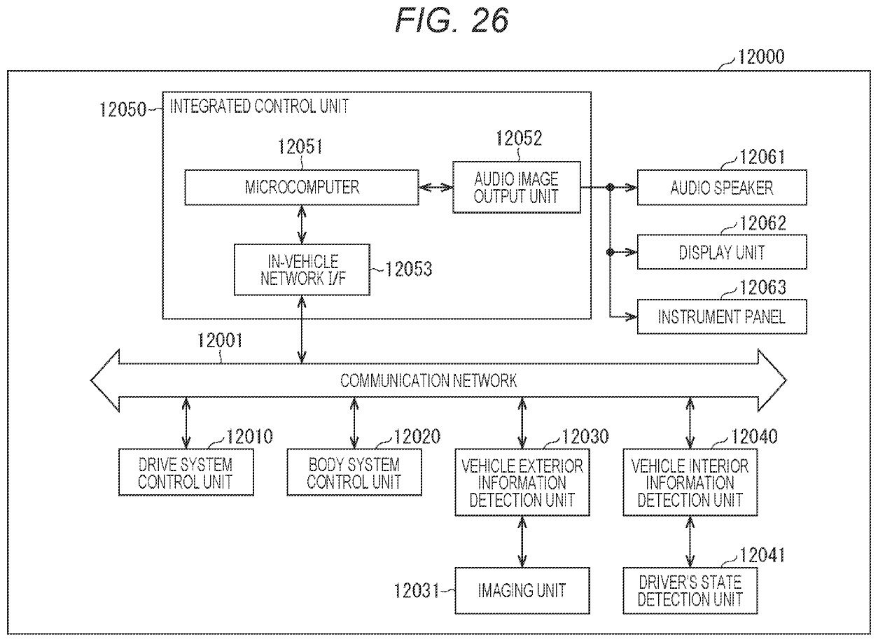

FIG. 26 is a block diagram illustrating a schematic configuration example of a vehicle control system that is an example of a mobile body control system to which the technology according to the present disclosure may be applied.

A vehicle control system 12000 is provided with a plurality of electronic control units connected to one another via a communication network 12001. In the example illustrated in FIG. 26, the vehicle control system 12000 is provided with a drive system control unit 12010, a body system control unit 12020, a vehicle exterior information detection unit 12030, a vehicle interior information detection unit 12040, and an integrated control unit 12050. Furthermore, a microcomputer 12051, an audio image output unit 12052, and an in-vehicle network interface (I/F) 12053 are illustrated as functional configurations of the integrated control unit 12050.

The drive system control unit 12010 controls an operation of a device related to a drive system of a vehicle according to various programs. For example, the drive system control unit 12010 serves as a control device of a driving force generating device for generating driving force of the vehicle such as an internal combustion engine, a driving motor or the like, a driving force transmitting mechanism for transmitting the driving force to wheels, a steering mechanism for adjusting a rudder angle of the vehicle, a braking device for generating braking force of the vehicle and the like.

The body system control unit 12020 controls operations of various devices mounted on a vehicle body according to the various programs. For example, the body system control unit 12020 serves as a control device of a keyless entry system, a smart key system, a power window device, or various lights such as a head light, a backing light, a brake light, a blinker, a fog light or the like. In this case, a radio wave transmitted from a portable device that substitutes for a key or signals of various switches may be input to the body system control unit 12020. The body system control unit 12020 receives an input of the radio wave or signals and controls a door locking device, a power window device, the lights and the like of the vehicle.

The vehicle exterior information detection unit 12030 detects information outside the vehicle equipped with the vehicle control system 12000. For example, an imaging unit 12031 is connected to the vehicle exterior information detection unit 12030. The vehicle exterior information detection unit 12030 allows the imaging unit 12031 to capture an image outside the vehicle and receives the captured image. The vehicle exterior information detection unit 12030 may perform detection processing of objects such as a person, a vehicle, an obstacle, a sign, a character on a road surface or the like or distance detection processing on the basis of the received image.

The imaging unit 12031 is an optical sensor that receives light and outputs an electric signal corresponding to an amount of the received light. The imaging unit 12031 may output the electric signal as an image or output the same as ranging information. Furthermore, the light received by the imaging unit 12031 may be visible light or invisible light such as infrared light and the like.

The vehicle interior information detection unit 12040 detects information inside the vehicle. The vehicle interior information detection unit 12040 is connected to, for example, a driver's state detection unit 12041 that detects a state of a driver. The driver's state detection unit 12041 includes, for example, a camera that images the driver, and the vehicle interior information detection unit 12040 may calculate a fatigue level or a concentration level of the driver or may determine whether or not the driver is dozing on the basis of detection information input from the driver's state detection unit 12041.

The microcomputer 12051 may perform an arithmetic operation of a control target value of the driving force generating device, the steering mechanism, or the braking device on the basis of the information inside and outside the vehicle obtained by the vehicle exterior information detection unit 12030 or the vehicle interior information detection unit 12040, and output a control instruction to the drive system control unit 12010. For example, the microcomputer 12051 may perform cooperative control for realizing functions of an advanced driver assistance system (ADAS) including collision avoidance or impact attenuation of the vehicle, following travel based on an inter-vehicular distance, vehicle speed maintaining travel, vehicle collision warning, vehicle lane departure warning or the like.

Furthermore, the microcomputer 12051 may perform the cooperative control for realizing automatic driving and the like to autonomously travel independent from the operation of the driver by controlling the driving force generating device, the steering mechanism, the braking device or the like on the basis of the information around the vehicle obtained by the vehicle exterior information detection unit 12030 or the vehicle interior information detection unit 12040.

Furthermore, the microcomputer 12051 may output the control instruction to the body system control unit 12020 on the basis of the information outside the vehicle obtained by the vehicle exterior information detection unit 12030. For example, the microcomputer 12051 may perform the cooperative control for realizing glare protection such as controlling the headlight according to a position of a preceding vehicle or an oncoming vehicle detected by the vehicle exterior information detection unit 12030 to switch a high beam to a low beam.

The audio image output unit 12052 transmits at least one of audio or image output signal to an output device capable of visually or audibly notifying an occupant of the vehicle or the outside the vehicle of the information. In the example in FIG. 26, as the output device, an audio speaker 12061, a display unit 12062, and an instrument panel 12063 are illustrated. The display unit 12062 may include at least one of an on-board display or a head-up display, for example.

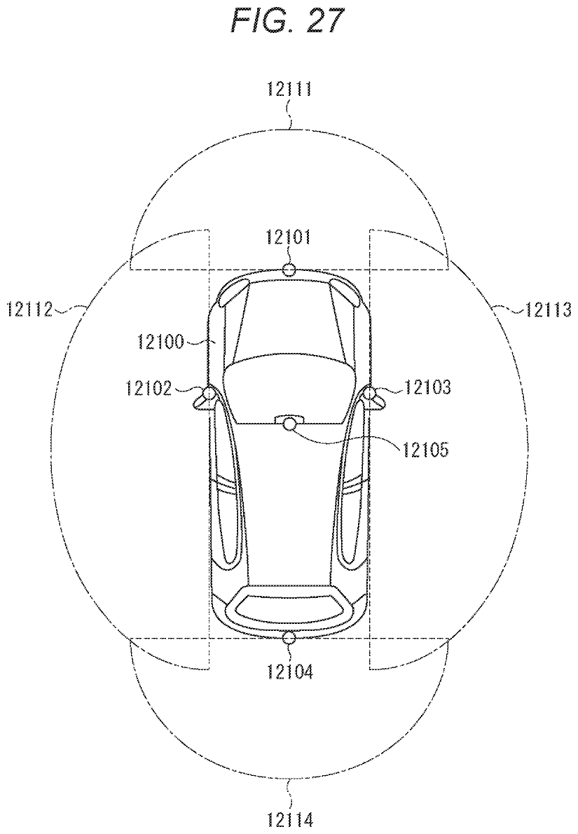

FIG. 27 is a view illustrating an example of an installation position of the imaging unit 12031.

In FIG. 27, the vehicle 12100 includes imaging units 12101, 12102, 12103, 12104, and 12105 as the imaging unit 12031.

The imaging units 12101, 12102, 12103, 12104, and 12105 are provided in positions such as, for example, a front nose, a side mirror, a rear bumper, a rear door, an upper portion of a front windshield in a vehicle interior and the like of the vehicle 12100. The imaging unit 12101 provided on the front nose and the imaging unit 12105 provided in the upper portion of the front windshield in the vehicle interior principally obtain images in front of the vehicle 12100. The imaging units 12102 and 12103 provided on the side mirrors principally obtain images of the sides of the vehicle 12100. The imaging unit 12104 provided on the rear bumper or the rear door principally obtains an image behind the vehicle 12100. The images in front obtained by the imaging units 12101 and 12105 are principally used for detecting a preceding vehicle, or a pedestrian, an obstacle, a traffic signal, a traffic sign, a lane or the like.

Note that, in FIG. 27, an example of imaging ranges of the imaging units 12101 to 12104 is illustrated. An imaging range 12111 indicates the imaging range of the imaging unit 12101 provided on the front nose, imaging ranges 12112 and 12113 indicate the imaging ranges of the imaging units 12102 and 12103 provided on the side mirrors, and an imaging range 12114 indicates the imaging range of the imaging unit 12104 provided on the rear bumper or the rear door. For example, image data imaged by the imaging units 12101 to 12104 are superimposed, so that an overlooking image of the vehicle 12100 as seen from above is obtained.

At least one of the imaging units 12101 to 12104 may have a function of obtaining distance information. For example, at least one of the imaging units 12101 to 12104 may be a stereo camera including a plurality of imaging elements, or may be an imaging element including pixels for phase difference detection.

For example, the microcomputer 12051 may extract especially a closest solid object on a traveling path of the vehicle 12100, the solid object traveling at a predetermined speed (for example, 0 km/h or higher) in a direction substantially the same as that of the vehicle 12100 as the preceding vehicle by obtaining a distance to each solid object in the imaging ranges 12111 to 12114 and a change in time of the distance (relative speed relative to the vehicle 12100) on the basis of the distance information obtained from the imaging units 12101 to 12104. Moreover, the microcomputer 12051 may set the inter-vehicle distance to be secured in advance from the preceding vehicle, and may perform automatic brake control (also including following stop control), automatic acceleration control (also including following start control) and the like. In this manner, it is possible to perform the cooperative control for realizing the automatic driving and the like to autonomously travel independent from the operation of the driver.

For example, the microcomputer 12051 may extract solid object data regarding the solid object while sorting the same into a motorcycle, a standard vehicle, a large-sized vehicle, a pedestrian, and other solid objects such as a utility pole and the like on the basis of the distance information obtained from the imaging units 12101 to 12104 and use for automatically avoiding obstacles. For example, the microcomputer 12051 discriminates the obstacles around the vehicle 12100 into an obstacle visible to a driver of the vehicle 12100 and an obstacle difficult to see. Then, the microcomputer 12051 determines a collision risk indicating a degree of risk of collision with each obstacle, and when the collision risk is equal to or higher than a set value and there is a possibility of collision, this may perform driving assistance for avoiding the collision by outputting an alarm to the driver via the audio speaker 12061 and the display unit 12062 or performing forced deceleration or avoidance steering via the drive system control unit 12010.

At least one of the imaging units 12101 to 12104 may be an infrared camera that detects infrared light. For example, the microcomputer 12051 may recognize a pedestrian by determining whether or not there is a pedestrian in the images captured by the imaging units 12101 to 12104. Such pedestrian recognition is carried out, for example, by a procedure of extracting feature points in the images captured by the imaging units 12101 to 12104 as the infrared cameras, and a procedure of performing pattern matching processing on a series of feature points indicating an outline of an object to discriminate whether or not this is a pedestrian. When the microcomputer 12051 determines that there is a pedestrian in the images captured by the imaging units 12101 to 12104 and recognizes the pedestrian, the audio image output unit 12052 controls the display unit 12062 to superimpose a rectangular contour for emphasis on the recognized pedestrian to display. Furthermore, the audio image output unit 12052 may control the display unit 12062 to display an icon and the like indicating the pedestrian in a desired position.

An example of the vehicle control system to which the technology according to the present disclosure may be applied is described above. The technology according to the present disclosure is applicable to the vehicle exterior information detection unit 12030 and the vehicle interior information detection unit 12040 out of the configurations described above. Specifically, by using the ranging by the ranging module 11 as the vehicle exterior information detection unit 12030 and the vehicle interior information detection unit 12040, it is possible to perform processing of recognizing a gesture of the driver, execute various operations (for example, an audio system, a navigation system, and an air conditioning system) according to the gesture, and more accurately detect the state of the driver. Furthermore, it is possible to recognize unevenness of a road surface using the ranging by the ranging module 11 and reflect the same in control of a suspension.

Note that the present technology may be applied to a method for performing amplitude modulation on light projected to an object referred to as a continuous-wave method among the indirect ToF methods. Furthermore, a structure of the photodiode 31 of the light reception unit 14 may be applied to a ranging sensor having a structure in which electric charges are distributed to two electric charge accumulation units, such as a ranging sensor having a current assisted photonic demodulator (CAPD) structure or a gate-type ranging sensor that alternately applies pulses of the electric charges of the photodiode to two gates. Furthermore, the present technology may be applied to a structured light-type ranging sensor.

The embodiments of the present technology are not limited to the above-described embodiments and various modifications may be made without departing from the gist of the present technology.

As long as there is no inconsistency, each of a plurality of present technologies described in this specification may be independently implemented alone. It goes without saying that it is also possible to implement by combining a plurality of arbitrary present technologies. For example, a part of or the entire present technology described in any of the embodiments may be implemented in combination with a part of or the entire present technology described in other embodiments. Furthermore, a part of or the entire arbitrary present technology described above may be implemented in combination with other technologies not described above.

Furthermore, for example, it is also possible to divide the configuration described as one device (or processing unit) into a plurality of devices (or processing units). Other way round, it is also possible to put the configurations described above as a plurality of devices (or processing units) together as one device (or processing unit). Furthermore, it goes without saying that it is possible to add a configuration other than the above-described one to the configuration of each device (or each processing unit). Moreover, it is also possible that a part of the configuration of a certain device (or processing unit) is included in the configuration of another device (or another processing unit) as long as a configuration and operation as an entire system are substantially the same.

Moreover, in this specification, the system is intended to mean assembly of a plurality of components (devices, modules (parts) and the like) and it does not matter whether or not all the components are in the same casing. Therefore, a plurality of devices stored in different casings and connected through a network and one device obtained by storing a plurality of modules in one casing are the systems.

Furthermore, for example, the above-described program may be executed by an arbitrary device. In this case, it is only required that the device has necessary functions (functional blocks and the like) so that necessary information may be obtained.

Note that the present technology may also take the following configuration.

(1)

A signal processing device provided with:
a parameter determination unit that determines an exposure control parameter on the basis of an evaluation index using distance information and luminance information calculated from a detection signal of a light receiving sensor.

(2)

The signal processing device according to (1) described above, further provided with:
an evaluation value calculation unit that calculates an evaluation value that is a value based on the evaluation index using the distance information and the luminance information, in which
the parameter determination unit determines the exposure control parameter on the basis of the evaluation value.

(3)

The signal processing device according to (2) described above, in which
the parameter determination unit determines the exposure control parameter with which the evaluation value becomes maximum.

(4)

The signal processing device according to (2) or (3) described above further provided with:
an evaluation index storage unit that stores the evaluation index, in which
the evaluation value calculation unit calculates the evaluation value based on the evaluation index supplied from the evaluation index storage unit.

(5)

The signal processing device according to any one of (1) to (4) described above, further provided with:
a distance image reliability calculation unit that generates a distance image as the distance information and a reliability image as the luminance information from the detection signal of the light receiving sensor; and
a statistic calculation unit that calculates a statistic of the distance image.

(6)

The signal processing device according to (5) described above, further provided with:
an image synthesis unit that generates a synthetic distance image obtained by synthesizing a first distance image with a first exposure control parameter and a second distance image with a second exposure control parameter, and a synthetic reliability image obtained by synthesizing a first reliability image with the first exposure control parameter and a second reliability image with the second exposure control parameter, in which
the distance image reliability calculation unit generates the first and second distance images and the first and second reliability images,
the statistic calculation unit calculates a statistic of the synthetic distance image, and
the parameter determination unit determines the first exposure control parameter and the second exposure control parameter.

(7)

The signal processing device according to (5) or (6) described above, in which
the evaluation index is a value calculated using the statistic of the distance image and the reliability image.

(8)

The signal processing device according to (7) described above, in which
the statistic of the distance image is an appearance frequency of the distance information.

(9)

The signal processing device according to (8) described above, in which
the evaluation index is a value calculated by an expression in which the appearance frequency of the distance information and an SN ratio corresponding to the distance information using the reliability image are convoluted.

(10)

The signal processing device according to any one of (1) to (9) described above, in which
the parameter determination unit determines a light emission amount of a light source that emits light received by the light receiving sensor as the exposure control parameter.

(11)

The signal processing device according to any one of (1) to (10), in which
the parameter determination unit determines a modulation frequency of a light source that emits light received by the light receiving sensor as the exposure control parameter.

(12)

The signal processing device according to any one of (1) to (11) described above, in which
the parameter determination unit determines an exposure time of the light receiving sensor as the exposure control parameter.

(13)

The signal processing device according to any one of (1) to (12) described above, in which
the parameter determination unit determines the exposure control parameter that shortens an exposure time of the light receiving sensor and increases a light emission amount of a light source that emits light received by the light receiving sensor in a case where a rate of ambient light components is large.

(14)

The signal processing device according to any one of (1) to (13) described above, further provided with:
a constraint setting unit that sets a constraint condition when determining the exposure control parameter, in which
the parameter determination unit determines the exposure control parameter that satisfies the constraint condition.

(15)

The signal processing device according to any one of (1) to (14) described above, further provided with: a region of interest determination unit that determines a region of interest especially focused on in an entire pixel region of the light receiving sensor, in which
the parameter determination unit determines the exposure control parameter on the basis of the evaluation index using distance information and luminance information of the region of interest.

(16)

The signal processing device according to (15) described above, in which
the region of interest determination unit determines the region of interest using at least one of the distance information or the luminance information.

(17)

The signal processing device according to (15) or (16) described above, in which
the region of interest determination unit determines the region of interest on the basis of a region specifying signal indicating the region of interest that is externally supplied.

(18)

A signal processing method, in which
a signal processing device determines an exposure control parameter on the basis of an evaluation index using distance information and luminance information calculated from a detection signal of a light receiving sensor.

(19)

A ranging module provided with:
a light emission unit that emits light at a predetermined frequency;
a light receiving sensor that receives reflected light that is light from the light emission unit reflected by an object; and
a parameter determination unit that determines an exposure control parameter on the basis of an evaluation index using distance information and luminance information calculated from a detection signal of the light receiving sensor.

### REFERENCE SIGNS LIST

11 Ranging module

12 Light emission unit

13 Light emission control unit

14 Light reception unit

15 Signal processing unit

21 Pixel

22 Pixel array unit

61 Distance image/reliability calculation unit

62 Statistic calculation unit

63 Evaluation value calculation unit

64 Evaluation index storage unit

65 Parameter determination unit

66 Parameter holding unit

81 Image synthesis unit

82 Constraint setting unit

91 Region of interest determination unit

92 Region of interest

201 Smartphone

202 Ranging module

301 CPU

302 ROM

303 RAM

1. A signal processing device comprising:
a parameter determination unit that determines an exposure control parameter on a basis of an evaluation index using distance information and luminance information calculated from a detection signal of a light receiving sensor.

2. The signal processing device according to claim 1, further comprising:
an evaluation value calculation unit that calculates an evaluation value that is a value based on the evaluation index using the distance information and the luminance information, wherein
the parameter determination unit determines the exposure control parameter on a basis of the evaluation value.

3. The signal processing device according to claim 2, wherein
the parameter determination unit determines the exposure control parameter with which the evaluation value becomes maximum.

4. The signal processing device according to claim 2, further comprising:
an evaluation index storage unit that stores the evaluation index, wherein
the evaluation value calculation unit calculates the evaluation value based on the evaluation index supplied from the evaluation index storage unit.

5. The signal processing device according to claim 1, further comprising:
a distance image reliability calculation unit that generates a distance image as the distance information and a reliability image as the luminance information from the detection signal of the light receiving sensor; and
a statistic calculation unit that calculates a statistic of the distance image.

6. The signal processing device according to claim 5, further comprising:
an image synthesis unit that generates a synthetic distance image obtained by synthesizing a first distance image with a first exposure control parameter and a second distance image with a second exposure control parameter, and a synthetic reliability image obtained by synthesizing a first reliability image with the first exposure control parameter and a second reliability image with the second exposure control parameter, wherein
the distance image reliability calculation unit generates the first and second distance images and the first and second reliability images,
the statistic calculation unit calculates a statistic of the synthetic distance image, and
the parameter determination unit determines the first exposure control parameter and the second exposure control parameter.

7. The signal processing device according to claim 5, wherein
the evaluation index is a value calculated using the statistic of the distance image and the reliability image.

8. The signal processing device according to claim 7, wherein
the statistic of the distance image is an appearance frequency of the distance information.

9. The signal processing device according to claim 8, wherein
the evaluation index is a value calculated by an expression in which the appearance frequency of the distance information and an SN ratio corresponding to the distance information using the reliability image are convoluted.

10. The signal processing device according to claim 1, wherein
the parameter determination unit determines a light emission amount of a light source that emits light received by the light receiving sensor as the exposure control parameter.

11. The signal processing device according to claim 1, wherein
the parameter determination unit determines a modulation frequency of a light source that emits light received by the light receiving sensor as the exposure control parameter.

12. The signal processing device according to claim 1, wherein
the parameter determination unit determines an exposure time of the light receiving sensor as the exposure control parameter.

13. The signal processing device according to claim 1, wherein
the parameter determination unit determines the exposure control parameter that shortens an exposure time of the light receiving sensor and increases a light emission amount of a light source that emits light received by the light receiving sensor in a case where a rate of ambient light components is large.

14. The signal processing device according to claim 1, further comprising:
a constraint setting unit that sets a constraint condition when determining the exposure control parameter, wherein
the parameter determination unit determines the exposure control parameter that satisfies the constraint condition.

15. The signal processing device according to claim 1, further comprising:
a region of interest determination unit that determines a region of interest especially focused on in an entire pixel region of the light receiving sensor, wherein
the parameter determination unit determines the exposure control parameter on a basis of the evaluation index using distance information and luminance information of the region of interest.

16. The signal processing device according to claim 15, wherein
the region of interest determination unit determines the region of interest using at least one of the distance information or the luminance information.

17. The signal processing device according to claim 15, wherein
the region of interest determination unit determines the region of interest on a basis of a region specifying signal indicating the region of interest that is externally supplied.

18. A signal processing method, wherein
a signal processing device determines an exposure control parameter on a basis of an evaluation index using distance information and luminance information calculated from a detection signal of a light receiving sensor.

19. A ranging module comprising:
a light emission unit that emits light at a predetermined frequency;
a light receiving sensor that receives reflected light that is light from the light emission unit reflected by an object; and
a parameter determination unit that determines an exposure control parameter on a basis of an evaluation index using distance information and luminance information calculated from a detection signal of the light receiving sensor.
